(19) United States
(12) Patent Application Publication
(10) Pub. No.: US 2026/0246294 A1
(43) Pub. Date: Aug. 20, 2026

(54) UNINTERRUPTIBLE POWER SUPPLY APPARATUS

(71) Applicant: TMEIC Corporation, Tokyo (JP)

(72) Inventors: Ryo MURATA, Chuo-ku (JP); Tomohiro TANAKA, Chuo-ku (JP)

(73) Assignee: TMEIC Corporation, Tokyo (JP)

(21) Appl. No.: 19/164,918

(22) PCT Filed: Feb. 15, 2024
(86) PCT No.: PCT/JP2024/005272

§ 371 Date: Sep. 12, 2025

(51) Int. Cl. H02J 9/06; H02M 1/14; H02M 7/217; H02M 7/48

(52) U.S. Cl. CPC H02J 9/062; H02M 1/14; H02M 7/217; H02M 7/48

(57) ABSTRACT

A converter includes a first multi-level circuit connected between a first reactor and first to third DC lines, and a second multi-level circuit connected between a second reactor and the first to third DC lines. A controller calculates a first voltage that is a sum of terminal-to-terminal voltages of first and second capacitors, and a second voltage that is a difference between the terminal-to-terminal voltages of the first and second capacitors. When an AC power supply is sound, the controller controls the first and second multi-level circuits such that the first voltage is equal to a reference voltage and the second voltage is eliminated. When the AC power supply has a power failure, the controller controls the first and second multi-level circuits such that the second voltage is eliminated.

### TECHNICAL FIELD

The present disclosure relates to an uninterruptible power supply apparatus.

### BACKGROUND ART

For example, Japanese Patent Laying-Open No. 2013-176296 (PTL 1) discloses an uninterruptible power supply apparatus including a converter, a direct current (DC) voltage converter, and an inverter. When an alternating current (AC) power supply is sound, the converter converts an AC voltage from the AC power supply into first to third DC voltages and outputs the first to third DC voltages to first to third DC lines. When the AC power supply has a power failure, the DC voltage converter converts a fourth DC voltage from a power storage device into first to third DC voltages and supplies the first to third DC voltages to the first to third DC lines. The inverter converts the first to third DC voltages from the first to third DC lines into AC voltages and supplies the AC voltages to a load.

This uninterruptible power supply apparatus further includes a first capacitor connected between the first and second DC lines, a second capacitor connected between the second and third DC lines, and a controller. As “balance control” for eliminating imbalance between terminal-to-terminal voltages of the first and second capacitors, when the AC power supply is sound, the controller controls the converter such that a first voltage that is the sum of the terminal-to-terminal voltages of the first and second capacitors is equal to a reference voltage, and a second voltage that is the difference between the terminal-to-terminal voltages of the first and second capacitors is eliminated. When the AC power supply has a power failure, the controller stops the operation of the converter, and controls the DC voltage converter such that the first voltage is equal to the reference voltage and the second voltage is eliminated.

As another method of balance control for first and second capacitors, WO 2020/105126 (PTL 2) discloses an uninterruptible power supply apparatus of a three-phase, four-wire system AC power supply and load. In this uninterruptible power supply apparatus, when the AC power supply is sound, a controller controls a converter such that a first voltage is equal to a reference voltage and a second voltage that is the difference between terminal-to-terminal voltages of first and second capacitors is eliminated. When the AC power supply has a power failure, the controller controls a DC voltage converter such that the first voltage is equal to the reference voltage and the second voltage is eliminated. When the AC power supply has a power failure and when an absolute value of the second voltage exceeds a prescribed threshold voltage, the controller further controls the converter to reduce the second voltage.

### CITATION LIST

### Patent Literature

PTL 1: Japanese Patent Laying-Open No. 2013-176296.

PTL 2: WO 2020/105126.

### SUMMARY OF INVENTION

### Technical Problem

In the balance control described in PTL 1, when the AC power supply has a power failure and when a load current is small, an output current of the DC voltage converter becomes smaller, which may result in difficulty in eliminating imbalance between the terminal-to-terminal voltages of the first and second capacitors.

In the balance control described in PTL 2, when the AC power supply has a power failure and when the absolute value of the second voltage exceeds the threshold voltage, the converter can be activated to thereby eliminate imbalance between the terminal-to-terminal voltages of the first and second capacitors even when a load current is small.

In PTL 2, however, when the AC power supply has a power failure, the AC power supply is electrically disconnected from an AC input filter, and the converter is operated using a capacitor (hereinafter also referred to as a “filter capacitor”) included in the AC input filter (LC filter circuit) as a power buffer, to discharge or charge the first and second capacitors. In this case, the magnitude of a current input to and output from each of the first and second capacitors depends on the difference between the terminal-to-terminal voltage of each of the first and second capacitors and a terminal-to-terminal voltage of the filter capacitor. However, since the uninterruptible power supply apparatus does not include a detector for detecting the terminal-to-terminal voltage of the filter capacitor, the difference between the terminal-to-terminal voltage of each of the first and second capacitors and the terminal-to-terminal voltage of the filter capacitor cannot be determined, which may result in difficulty in performing the balance control by the converter.

Furthermore, in PTL 2, when the difference between the terminal-to-terminal voltage of each of the first and second capacitors and the terminal-to-terminal voltage of the filter capacitor is eliminated, the first and second capacitors cannot be discharged or charged even when the converter is operated, resulting in the need for an operation for discharging the filter capacitor. In PTL 2, therefore, the second voltage is reduced by alternate repetition of the operation of discharging or charging the first and second capacitors and the operation of discharging the filter capacitor. This may result in difficulty in quickly eliminating imbalance between the first and second capacitors, when the AC power supply has a power failure.

The present disclosure has been made to solve the above problem, and an object of the present disclosure is to provide an uninterruptible power supply apparatus capable of easily and quickly eliminating imbalance between terminal-to-terminal voltages of first and second capacitors, when an AC power supply has a power failure.

### Solution to Problem

An uninterruptible power supply apparatus according to one aspect of the present disclosure includes a first DC line, a second DC line and a third DC line, a first capacitor, a second capacitor, a switch, an AC input filter, a converter, an inverter, a first voltage detector and a second voltage detector, and a controller. The first capacitor is connected between the first DC line and the second DC line. The second capacitor is connected between the second DC line and the third DC line. The switch has a first terminal that receives an AC voltage supplied from an AC power supply, and is turned on when the AC power supply is sound and turned off when the AC power supply has a power failure. The AC input filter has a first terminal connected to a second terminal of the switch. The converter is connected between a second terminal of the AC input filter and the first to third DC lines. The converter converts AC power from the AC power supply into DC power and supplies the DC power to the first to third DC lines when the AC power supply is sound. The inverter is connected between the first to third DC lines and a load, and converts DC power from the first to third DC lines into AC power and supplies the AC power to the load. The first voltage detector and the second voltage detector detect a terminal-to-terminal voltage of the first capacitor and a terminal-to-terminal voltage of the second capacitor, respectively. The controller controls the converter based on a detection value of the first voltage detector and a detection value of the second voltage detector.

The AC input filter includes a first reactor having a first terminal connected to the second terminal of the switch, and a second reactor having a first terminal connected to the second terminal of the switch. The converter includes a first multi-level circuit and a second multi-level circuit. The first multi-level circuit is connected between a second terminal of the first reactor and the first to third DC lines, and is configured to be able to perform conversion between an AC voltage and first to third DC voltages. The second multi-level circuit is connected between a second terminal of the second reactor and the first to third DC lines, and is configured to be able to perform conversion between an AC voltage and the first to third DC voltages.

The controller calculates, based on the detection value of the first voltage detector and the detection value of the second voltage detector, a first voltage that is a sum of the terminal-to-terminal voltage of the first capacitor and the terminal-to-terminal voltage of the second capacitor, and a second voltage that is a difference between the terminal-to-terminal voltage of the first capacitor and the terminal-to-terminal voltage of the second capacitor. When the AC power supply is sound, the controller controls the first multi-level circuit and the second multi-level circuit such that the first voltage is equal to a reference voltage and the second voltage is eliminated. When the AC power supply has a power failure, the controller controls the first multi-level circuit and the second multi-level circuit such that the second voltage is eliminated.

### Advantageous Effects of Invention

According to the present disclosure, there can be provided an uninterruptible power supply apparatus capable of easily and quickly eliminating imbalance between terminal-to-terminal voltages of first and second capacitors, when an AC power supply has a power failure.

### BRIEF DESCRIPTION OF DRAWINGS

FIG. 1 is a block diagram showing an overall configuration of an uninterruptible power supply apparatus according to a first embodiment.

FIG. 2 is a block diagram showing a hardware configuration example of a controller.

FIG. 3 is a circuit diagram showing a configuration example of a converter shown in FIG. 1.

FIG. 4 is a circuit diagram showing a configuration example of a DC voltage converter shown in FIG. 1.

FIG. 5 is a block diagram showing a part of the controller related to control of the converter and the DC voltage converter.

FIG. 6 is a block diagram showing a configuration of a first control circuit shown in FIG. 5.

FIG. 7 is a block diagram showing a configuration of a PWM circuit shown in FIG. 6.

FIG. 8 is a time chart showing waveforms of a voltage command value, triangular wave signals and PWM signals shown in FIG. 7.

FIG. 9 shows a switching pattern of four IGBTs included in each bridge circuit.

FIG. 10 is a time chart showing an operation of a second control circuit shown in FIG. 5.

FIG. 11 is an equivalent circuit diagram showing an operation for one phase of the converter when Ep>En.

FIG. 12 is an equivalent circuit diagram showing an operation for one phase of the converter when Ep>En.

FIG. 13 is a time chart showing an operation of the second control circuit shown in FIG. 5.

FIG. 14 is an equivalent circuit diagram showing an operation for one phase of the converter when Ep<En.

FIG. 15 is an equivalent circuit diagram showing an operation for one phase of the converter when Ep<En.

FIG. 16 is a block diagram showing a configuration of a control circuit shown in FIG. 5.

FIG. 17 is a flowchart showing an example of balance control by the converter when a commercial AC power supply has a power failure.

FIG. 18 is a circuit diagram showing a main part of an uninterruptible power supply apparatus according to a third embodiment.

FIG. 19 shows a switching pattern of the four IGBTs included in each bridge circuit.

FIG. 20 is a time chart showing an operation of the second control circuit.

FIG. 21 is an equivalent circuit diagram showing an operation for one phase of the converter when Ep>En.

FIG. 22 is an equivalent circuit diagram showing an operation for one phase of the converter when Ep>En.

FIG. 23 is a time chart showing an operation of the second control circuit.

FIG. 24 is an equivalent circuit diagram showing an operation for one phase of the converter when Ep<En.

FIG. 25 is an equivalent circuit diagram showing an operation for one phase of the converter when Ep<En.

### DESCRIPTION OF EMBODIMENTS

Embodiments of the present disclosure will be described hereinafter in detail with reference to the drawings. The same or corresponding parts in the drawings are denoted by the same reference characters and the description thereof will not be repeated.

### First Embodiment

### <Configuration of Uninterruptible Power Supply Apparatus>

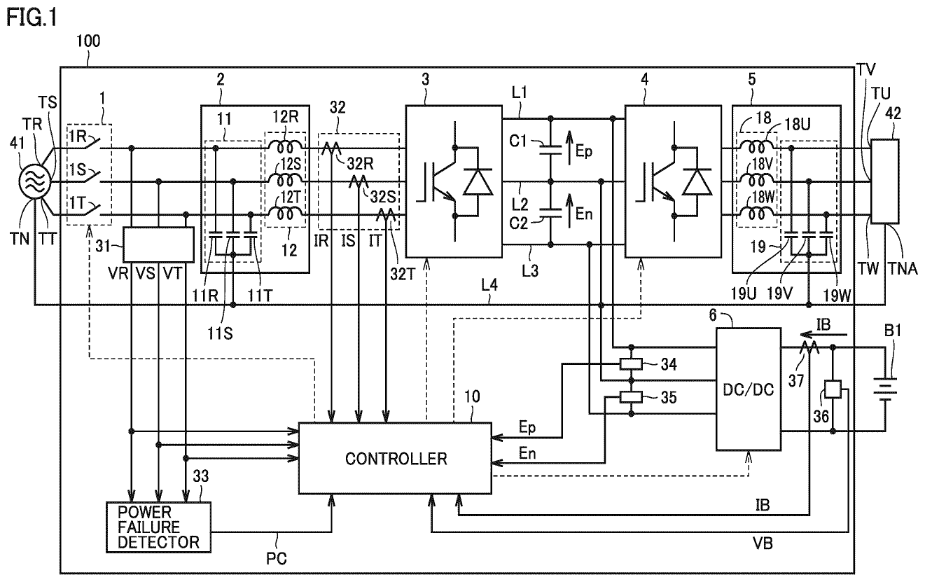

FIG. 1 is a block diagram showing an overall configuration of an uninterruptible power supply apparatus 100 according to a first embodiment. As shown in FIG. 1, uninterruptible power supply apparatus 100 includes a switch 1, an AC input filter 2, a converter 3, an inverter 4, an AC output filter 5, a DC voltage converter (hereinafter denoted as “DC/DC”) 6, a controller 10, DC lines L1 to L3, a neutral point line L4, capacitors C1 and C2, voltage detectors 31, 34 and 35, current detectors 32 and 37, and a power failure detector 33.

Switch 1 includes switches 1R, 1S and 1T. First terminals of switches 1R, 1S and 1T are connected to an R-phase terminal TR, an S-phase terminal TS and a T-phase terminal TT of a commercial AC power supply 41, respectively, and receive an R-phase voltage VR, an S-phase voltage VS and a T-phase voltage VT supplied from commercial AC power supply 41, respectively. A neutral point terminal TN of commercial AC power supply 41 is connected to one end of neutral point line L4.

Switches 1R, 1S and 1T are controlled by controller 10. Switches 1R, 1S and 1T are turned on when three-phase AC power is normally supplied from commercial AC power supply 41 (when commercial AC power supply 41 is sound), and are turned off when the supply of three-phase AC power from commercial AC power supply 41 is stopped (when commercial AC power supply 41 has a power failure). Switches 1R, 1S and 1T are turned off when commercial AC power supply 41 has a power failure, to electrically disconnect commercial AC power supply 41 from AC input filter 2.

AC input filter 2 is a three-phase LC filter circuit implemented by a capacitor 11 (capacitors 11R, 11S and 11T) and a reactor 12 (reactors 12R, 12S and 12T). The positive electrodes of capacitors 11R, 11S and 11T are connected to second terminals of switches 1R, 1S and 1T, respectively, and the negative electrodes thereof are connected together to neutral point line L4. First terminals of reactors 12R, 12S and 12T are connected to the second terminals of switches 1R, 1S and 1T, respectively, and second terminals of reactors 12R, 12S and 12T are connected to three input nodes of converter 3, respectively.

AC input filter 2 is a low-pass filter, which allows AC power of a commercial frequency supplied from commercial AC power supply 41 to flow to converter 3 and prevents a signal of a switching frequency generated in converter 3 from flowing to the commercial AC power supply 41 side.

First ends of DC lines L1 to L3 are connected to three output nodes of converter 3, and second ends thereof are connected to three input nodes of inverter 4. DC line L2 is connected to neutral point line L4. DC lines L1 to L3 are connected to three high-voltage side nodes of DC voltage converter 6. DC lines L1 to L3 are set to a positive voltage, a neutral point voltage and a negative voltage, respectively, by converter 3 and DC voltage converter 6.

Capacitor C1 is connected between DC lines L1 and L2, and smooths and stabilizes a DC voltage Ep between DC lines L1 and L2. Capacitor C2 is connected between DC lines L2 and L3, and smooths and stabilizes a DC voltage En between DC lines L2 and L3.

Converter 3 is controlled by controller 10. When commercial AC power supply 41 is sound, converter 3 converts three-phase AC power supplied from commercial AC power supply 41 through AC input filter 2 into DC power, and supplies the DC power to inverter 4 and DC voltage converter 6 through DC lines L1 to L3.

In doing so, controller 10 controls converter 3 such that a DC voltage VDC=Ep+En that is the sum of DC voltages Ep and En is equal to a reference DC voltage VDCR, and a DC voltage ΔE=Ep−En that is the difference between DC voltages Ep and En becomes zero.

When commercial AC power supply 41 has a power failure, controller 10 controls converter 3 such that DC voltage ΔE=Ep−En that is the difference between DC voltages Ep and En becomes zero. When DC voltage ΔE=Ep−En that is the difference between DC voltages Ep and En becomes zero, controller 10 stops the operation of converter 3.

Inverter 4 is controlled by controller 10. Inverter 4 converts DC power from converter 3 and DC voltage converter 6 into three-phase AC power of a commercial frequency. The three-phase AC power generated by inverter 4 is supplied to a load 42 through AC output filter 5.

AC output filter 5 is a three-phase LC filter circuit implemented by a reactor 18 (reactors 18U, 18V and 18W) and a capacitor 19 (capacitors 19U, 19V and 19W). First terminals of reactors 18U, 18V and 18W are connected to three output nodes of inverter 4, respectively, and second terminals thereof are connected to a U-phase terminal TU, a V-phase terminal TV and a W-phase terminal TW of load 42.

The positive electrodes of capacitors 19U, 19V and 19W are connected to second terminals of reactors 18U, 18V and 18W, and the negative electrodes thereof are connected together to neutral point line L4. AC output filter 5 is a low-pass filter, which allows three-phase AC power of a commercial frequency generated by inverter 4 to pass therethrough and prevents a signal of a switching frequency generated in inverter 4 from flowing to load 42. A neutral point terminal TNA of load 42 is connected to neutral point line LA. Load 42 is driven by three-phase AC power supplied from uninterruptible power supply apparatus 100.

A battery B1 (power storage device) is connected between two low-voltage nodes of DC voltage converter 6. DC voltage converter 6 is controlled by controller 10. When commercial AC power supply 41 is sound, DC voltage converter 6 stores DC power generated by converter 3 in battery B1. In doing so, controller 10 controls DC voltage converter 6 such that a terminal-to-terminal voltage VB of battery B1 is equal to a reference battery voltage VBR.

When commercial AC power supply 41 has a power failure, DC voltage converter 6 supplies DC power in battery B1 to inverter 4 through DC lines L1 to L3. In doing so, controller 10 controls DC voltage converter 6 such that DC voltage VDC=Ep+En that is the sum of DC voltages Ep and En is equal to reference DC voltage VDCR.

A capacitor (e.g., an electric double layer capacitor) may be connected, in place of battery B1, to DC voltage converter 6. Although battery B1 is installed outside of uninterruptible power supply apparatus 100 in the present embodiment, battery B1 may be incorporated in uninterruptible power supply apparatus 100.

Voltage detector 31 detects instantaneous values of AC voltages VR, VS and VT at the second terminals of switches 1R, 1S and 1T, and outputs three-phase voltage signals indicating three-phase AC voltages VR, VS and VT to controller 10 and power failure detector 33. Current detector 32 detects instantaneous values of AC currents IR, IS and IT flowing into the three input nodes of converter 3, and outputs three-phase current signals indicating three-phase AC currents IR, IS and IT to controller 10.

Power failure detector 33 determines whether a power failure of commercial AC power supply 41 has occurred based on the three-phase voltage signals from voltage detector 31, and outputs a power failure signal PC indicating a result of the determination. When commercial AC power supply 41 is sound, power failure signal PC is “L” level which is the inactivation level. When commercial AC power supply 41 has a power failure, power failure signal PC is “H” level which is the activation level. Power failure signal PC is provided to controller 10.

Voltage detector 34 detects terminal-to-terminal voltage Ep of capacitor C1, and outputs a signal indicating detected voltage Ep to controller 10. Voltage detector 35 detects terminal-to-terminal voltage En of capacitor C2, and outputs a signal indicating detected voltage En to controller 10. A voltage detector 36 detects terminal-to-terminal voltage VB of battery B1, and outputs a signal indicating detected voltage VB to controller 10. Current detector 37 detects a current IB output from battery B1, and outputs a signal indicating detected current IB to controller 10.

Upon receiving the three-phase voltage signals from voltage detector 31, the three-phase current signals from current detector 32, the signals from voltage detectors 34 to 36, the signal from current detector 37, power failure signal PC from power failure detector 33 and the like, controller 10 controls entire uninterruptible power supply apparatus 100.

Converter 3, inverter 4 and DC voltage converter 6 are each implemented by a semiconductor switch including a semiconductor switching element. In the present embodiment, an IGBT (Insulated Gate Bipolar Transistor) is employed as the semiconductor switching element. PWM (Pulse Width Modulation) control is applicable as a method of controlling the semiconductor switching element.

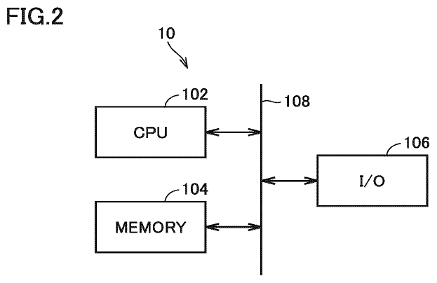

FIG. 2 is a block diagram showing a hardware configuration example of controller 10. As shown in FIG. 2, controller 10 includes a CPU (Central Processing Unit) 102, a memory 104, and an input/output (I/O) circuit 106. CPU 102, memory 104 and I/O circuit 106 can exchange data with each other via a bus 108. A program is stored in a partial area of memory 104, and when the program is executed by CPU 102, various functions which will be described later can be performed. I/O circuit 106 inputs and outputs a signal and data to and from the outside of controller 10.

Alternatively, unlike the example of FIG. 2, controller 10 can at least partially be implemented using a circuit such as an FPGA (Field Programmable Gate Array) or an ASIC (Application Specific Integrated Circuit). Controller 10 can at least partially be implemented by an analog circuit.

### (Circuit Configuration Example of Converter)

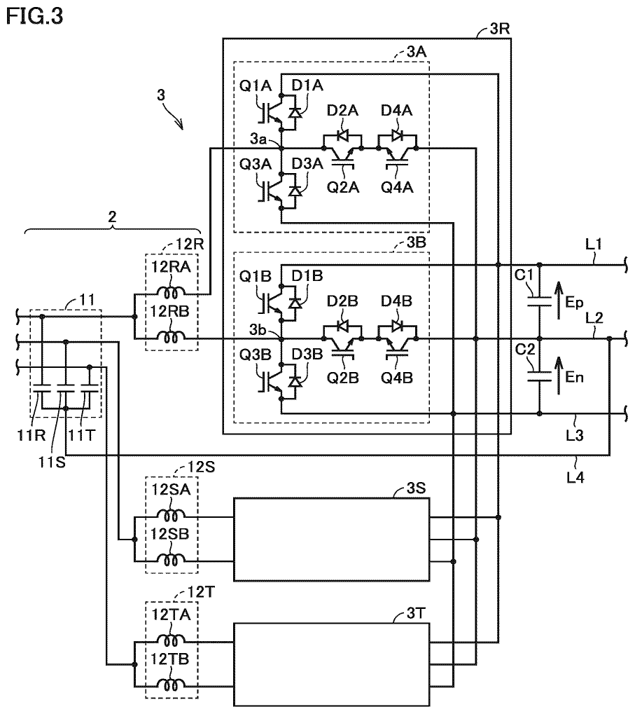

FIG. 3 is a circuit diagram showing a configuration example of converter 3 shown in FIG. 1. As shown in FIG. 3, converter 3 includes an R-phase arm 3R, an S-phase arm 3S and a T-phase arm 3T. Since each of phase arms 3R, 3S and 3T of converter 3 has the same circuit configuration, the circuit configuration of R-phase arm 3R is representatively described.

As shown in FIG. 3, reactor 12R includes reactors 12RA and 12RB. R-phase arm 3R includes three-level circuits 3A and 3B. A first terminal of reactor 12RA is connected to the second terminal of switch 1R, and a second terminal of reactor 12RA is connected to an input node 3a of three-level circuit 3A. A first terminal of reactor 12RB is connected to the second terminal of switch 1R, and a second terminal of reactor 12RB is connected to an input node 3b of three-level circuit 3B. Reactor 12RA corresponds to an example of “first reactor,” and reactor 12RB corresponds to an example of “second reactor.”

Three-level circuit 3A includes IGBTs Q1A to Q4A and diodes D1A to D4A. The collector of IGBT Q1A is connected to DC line L1, and the emitter thereof is connected to input node 3a. The emitters of IGBTs Q2A and Q4A are connected to each other, and the collectors thereof are connected to input node 3a and DC line L2, respectively. The collector of IGBT Q3A is connected to input node 3a, and the emitter thereof is connected to DC line L3. Diodes D1A to D4A are connected in anti-parallel to IGBTs Q1A to Q4A, respectively.

Three-level circuit 3A corresponds to an example of “first multi-level circuit.” IGBT Q1A and diode D1A constitute a “first switch,” IGBTs Q2A and Q4A and diodes D2A and D4A constitute a “second switch,” and IGBT Q3A and diode D3A constitute a “third switch.”

Three-level circuit 3B includes IGBTs Q1B to Q4B and diodes D1B to D4B. The collector of IGBT Q1B is connected to DC line L1, and the emitter thereof is connected to input node 3b. The emitters of IGBTs Q2B and Q4B are connected to each other, and the collectors thereof are connected to input node 3b and DC line L2, respectively. The collector of IGBT Q3B is connected to input node 3b, and the emitter thereof is connected to DC line L3. Diodes D1B to D4B are connected in anti-parallel to IGBTs Q1B to Q4B, respectively.

Three-level circuit 3B corresponds to an example of “second multi-level circuit.” IGBT Q1B and diode D1B constitute a “fourth switch,” IGBTs Q2B and Q4B and diodes D2B and D4B constitute a “fifth switch,” and IGBT Q3B and diode D3B constitute a “sixth switch.”

### (Circuit Configuration Example of DC Voltage Converter)

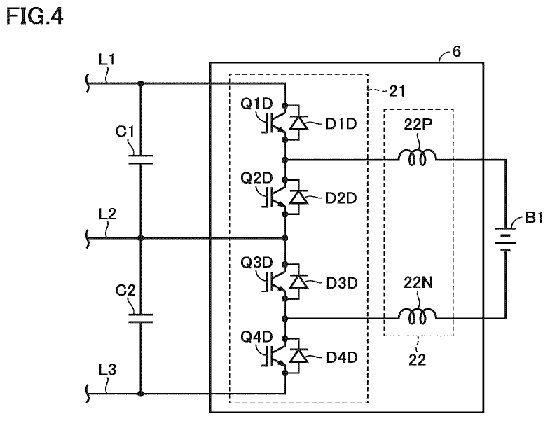

FIG. 4 is a circuit diagram showing a configuration example of DC voltage converter 6 shown in FIG. 1. As shown in FIG. 4, DC voltage converter 6 includes a semiconductor switch 21 and a reactor 22. Semiconductor switch 21 is implemented as a three-level circuit, and includes IGBTs Q1D to Q4D connected in series between DC lines L1 and L3, and diodes DID to D4D connected in anti-parallel to IGBTs Q1D to Q4D, respectively.

Reactor 22 includes reactors 22P and 22N. Reactor 22P is connected between a connection point between IGBTs Q1D and Q2D and the positive electrode of battery B1. Reactor 22N is connected between a connection point between IGBTs Q3D and Q4D and the negative electrode of battery B1. It is noted that reactor 22 only needs to include one of reactors 22P and 22N.

### <Control Configuration of Uninterruptible Power Supply Apparatus>

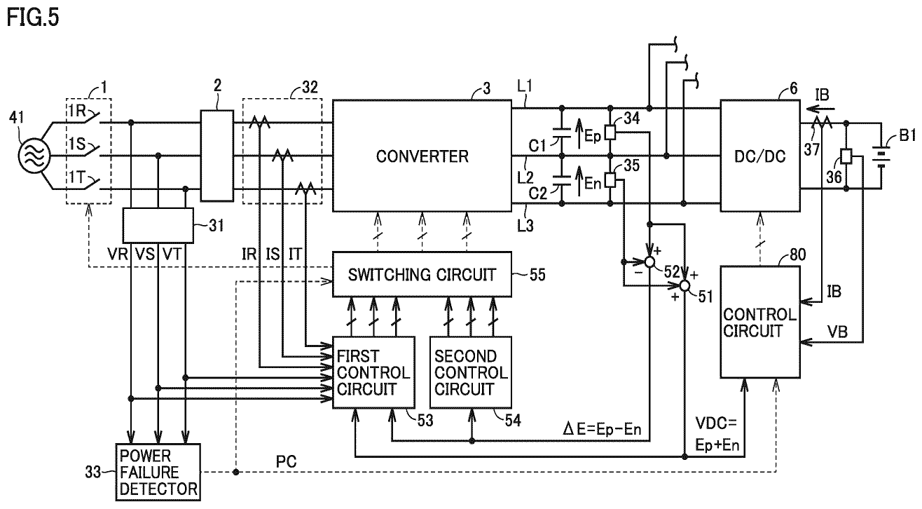

FIG. 5 is a block diagram showing a part of controller 10 related to control of converter 3 and DC voltage converter 6.

As shown in FIG. 5, controller 10 includes an adder 51, a subtractor 52, a first control circuit 53, a second control circuit 54, a switching circuit 55, and a control circuit 80.

Adder 51 adds terminal-to-terminal voltages Ep and En of capacitors C1 and C2 detected by voltage detectors 34 and 35, and determines DC voltage VDC=Ep+En between DC lines L1 and L3. DC voltage VDC is provided to each of control circuits 53 and 80.

Subtractor 52 subtracts terminal-to-terminal voltage En of capacitor C2 detected by voltage detector 35 from terminal-to-terminal voltage Ep of capacitor C1 detected by voltage detector 34, and determines DC voltage ΔE=Ep−En that is the difference between terminal-to-terminal voltages Ep and En of capacitors C1 and C2. DC voltage ΔE is provided to each of control circuits 53, 54 and 80.

First control circuit 53 controls converter 3 based on the three-phase voltage signals from voltage detector 31, the three-phase current signals from current detector 32, a signal indicating DC voltage VDC from adder 51, and a signal indicating DC voltage ΔE from subtractor 52. Specifically, first control circuit 53 controls converter 3 such that three-phase AC voltages VR, VS and VT are in phase with three-phase AC currents IR, IS and IT, DC voltage VDC is equal to reference DC voltage VDCR, and DC voltage ΔE becomes zero.

Second control circuit 54 controls converter 3 based on the signal indicating DC voltage ΔE from subtractor 52. Specifically, second control circuit 54 controls converter 3 such that DC voltage ΔE becomes zero.

Switching circuit 55 is provided between control circuits 53 and 54 and converter 3. Switching circuit 55 connects one of control circuits 53 and 54 to converter 3 based on power failure signal PC from power failure detector 33. Specifically, when power failure signal PC is “L” level which is the inactivation level (when commercial AC power supply 41 is sound), switching circuit 55 connects first control circuit 53 to converter 3. When power failure signal PC is “H” level which is the activation level (when commercial AC power supply 41 has a power failure), switching circuit 55 connects second control circuit 54 to converter 3.

Switching circuit 55 further controls on/off of switches 1R, 1S and 1T based on power failure signal PC from power failure detector 33. Specifically, when power failure signal PC is “L” level which is the inactivation level (when commercial AC power supply 41 is sound), switching circuit 55 turns on switches 1R, 1S and 1T. When power failure signal PC is “H” level which is the activation level (when commercial AC power supply 41 has a power failure), switching circuit 55 turns off switches 1R, 1S and 1T.

### (Configuration of First Control Circuit)

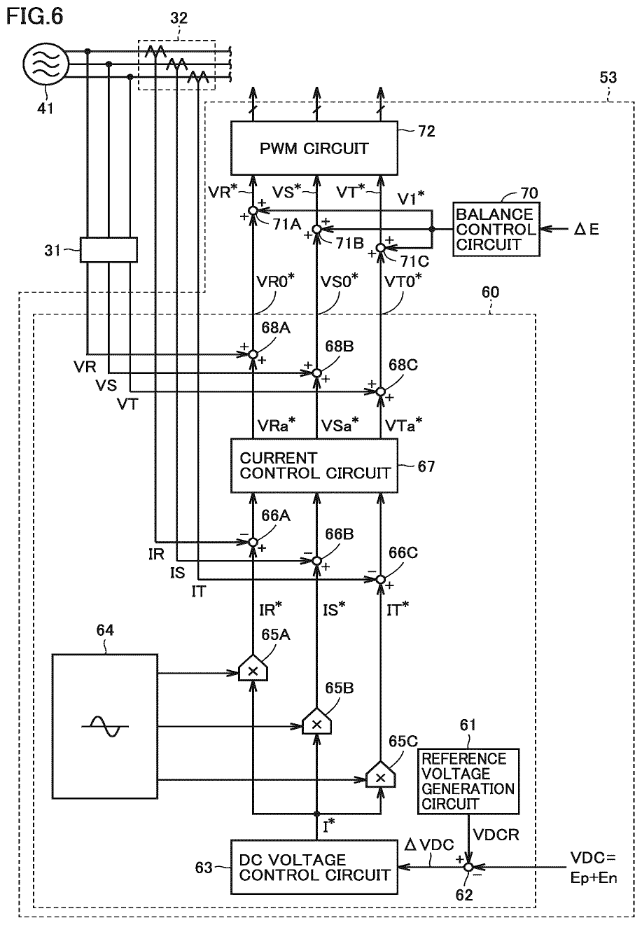

FIG. 6 is a block diagram showing a configuration of first control circuit 53 shown in FIG. 5. As shown in FIG. 6, first control circuit 53 includes a voltage command generation circuit 60, a balance control circuit 70, adders 71A to 71C, and a PWM circuit 72.

Voltage command generation circuit 60 includes a reference voltage generation circuit 61, subtractors 62 and 66A to 66C, a DC voltage control circuit 63, a sinusoidal wave generation circuit 64, multipliers 65A to 65C, a current control circuit 67, and adders 68A to 68C.

Reference voltage generation circuit 61 generates reference DC voltage VDCR. Subtractor 62 calculates a voltage AVDC=VDCR−VDC that is the difference between reference DC voltage VDCR and DC voltage VDC from adder 51. DC voltage control circuit 63 calculates a current command value I* for controlling a current flowing to the input side of converter 3 such that voltage ΔVDC becomes zero. DC voltage control circuit 63 calculates current command value I* by, for example, proportional operation or proportional integral operation of ΔVDC.

Sinusoidal wave generation circuit 64 outputs a sinusoidal wave signal of the same phase as R-phase voltage VR of commercial AC power supply 41, a sinusoidal wave signal of the same phase as S-phase voltage VS of commercial AC power supply 41, and a sinusoidal wave signal of the same phase as T-phase voltage VT of commercial AC power supply 41. The three sinusoidal wave signals are input to multipliers 65A to 65C, respectively, and are multiplied by current command value I*. Thus, current command values IR*, IS* and IT* of the same phases as three-phase AC voltages VR, VS and VT of commercial AC power supply 41 are generated.

Subtractor 66A calculates a difference between current command value IR* and R-phase current IR detected by a current detector 32R. Subtractor 66B calculates a difference between current command value IS* and S-phase current IS detected by a current detector 32S. Subtractor 66C calculates a difference between current command value IT* and T-phase current IT detected by a current detector 32T.

Current control circuit 67 generates voltage command values VRa*, VSa* and VTa*, as voltages to be applied to reactor 12 such that all of the difference between current command value IR* and R-phase current IR, the difference between current command value IS* and S-phase current IS, and the difference between current command value IT* and T-phase current IT become zero. Current control circuit 67 generates the voltage command value by, for example, amplifying the difference between the current command value and the current value detected by current detector 32 in accordance with proportional control or proportional integral control.

Adder 68A adds voltage command value VRa* and R-phase voltage VR detected by voltage detector 31 and generates a voltage command value VR0*. Adder 68B adds voltage command value VSa* and S-phase voltage VS detected by voltage detector 31 and generates a voltage command value VS0*. Adder 68C adds voltage command value VTa* and T-phase voltage VT detected by voltage detector 31 and generates a voltage command value VT0*.

As described above, upon receiving three-phase AC voltages VR, VS and VT detected by voltage detector 31, three-phase AC currents IR, IS and IT detected by current detector 32, and DC voltage VDC calculated by adder 51, voltage command generation circuit 60 generates voltage command values VR0*, VS0* and VT0* corresponding to the R-phase, the S-phase and the T-phase, respectively.

Balance control circuit 70 generates a voltage command value V1* based on DC voltage ΔE=Ep−En from subtractor 52. For example, balance control circuit 70 generates voltage command value V1* by proportional operation or proportional integral operation of ΔE. When ΔE=Ep−En>0, voltage command value V1* is generated such that a charging time of capacitor C1 is shorter than a charging time of capacitor C2. When ΔE=Ep−En<0, voltage command value V1* is generated such that the charging time of capacitor C1 is longer than the charging time of capacitor C2.

Adder 71A adds voltage command values VR0* and V1* and generates a voltage command value VR*. Adder 71B adds voltage command values VS0* and V1* and generates a voltage command value VS*. Adder 71C adds voltage command values VT0* and V1* and generates a voltage command value VT*. Voltage command values VR*, VS* and VT* are sinusoidal wave signals of a commercial frequency.

Based on voltage command values VR*, VS* and VT*, PWM circuit 72 outputs signals for equalizing three-phase AC voltages VR, VS and VT detected by voltage detector 31 with voltage command values VR*, VS* and VT*, respectively. These signals are PWM signals φ1A to φ4A and φ1B to φ4B for controlling on/off of eight IGBTs Q1A to Q4A and Q1B to Q4B included in each phase arm of converter 3.

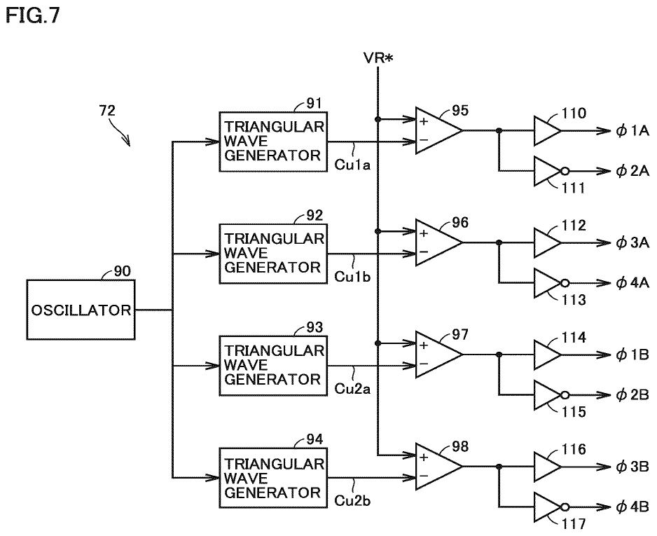

FIG. 7 is a block diagram showing a configuration of PWM circuit 72 shown in FIG. 6. FIG. 7 shows a configuration of a part related to control of R-phase arm 3R.

As shown in FIG. 7, PWM circuit 72 includes an oscillator 90, triangular wave generators 91 to 94, comparators 95 to 98, buffers 110, 112, 114 and 116, and NOT circuits 111, 113, 115 and 117.

Oscillator 90 outputs a clock signal of a frequency sufficiently higher than a commercial frequency. Triangular wave generators 91 to 94 output triangular wave signals Cu1a, Cu1b, Cu2a and Cu2b of the same frequency as that of the clock signal output from oscillator 90, respectively.

Triangular wave signals Cu1a and Cu1b are signals of the same phase. Triangular wave signals Cu2a and Cu2b are signals of the same phase. Triangular wave signal Cula and triangular wave signal Cu2a are of different phases. In the example of FIG. 7, triangular wave signal Cu2a is shifted in phase by 180° relative to triangular wave signal Cu1a.

Comparator 95 compares voltage command value VR* with triangular wave signal Cu1a from triangular wave generator 91 to determine which is higher, and outputs PWM signal φ1A indicating a result of the comparison. Buffer 110 provides PWM signal φ1A to three-level circuit 3A. NOT circuit 111 inverts PWM signal φ1A, and generates and provides PWM signal φ2A to three-level circuit 3A. IGBTs Q1A and Q2A are turned on when PWM signals φ1A and φ2A are “H” level, respectively, and are turned off when PWM signals φ1A and φ2A are “L” level, respectively.

Comparator 96 compares voltage command value VR* with triangular wave signal Cu1b from triangular wave generator 92 to determine which is higher, and outputs PWM signal φ3A indicating a result of the comparison. Buffer 112 provides PWM signal φ3A to three-level circuit 3A. NOT circuit 113 inverts PWM signal φ3A, and generates and provides PWM signal φ4A to three-level circuit 3A. IGBTs Q3A and Q4A are turned on when PWM signals φ3A and φ4A are “H” level, respectively, and are turned off when PWM signals φ3A and φ4A are “L” level, respectively.

Comparator 97 compares voltage command value VR* with triangular wave signal Cu2a from triangular wave generator 93 to determine which is higher, and outputs PWM signal φ1B indicating a result of the comparison. Buffer 114 provides PWM signal φ1B to three-level circuit 3B. NOT circuit 115 inverts PWM signal φ1B, and generates and provides PWM signal φ2B to three-level circuit 3B. IGBTs Q1B and Q2B are turned on when PWM signals φ1B and φ2B are “H” level, respectively, and are turned off when PWM signals φ1B and φ2B are “L” level, respectively.

Comparator 98 compares voltage command value VR* with triangular wave signal Cu2b from triangular wave generator 94 to determine which is higher, and outputs PWM signal φ3B indicating a result of the comparison. Buffer 116 provides PWM signal φ3B to three-level circuit 3B. NOT circuit 117 inverts PWM signal φ3B, and generates and provides PWM signal φ4B to three-level circuit 3B. IGBTs Q3B and Q4B are turned on when PWM signals φ3B and φ4B are “H” level, respectively, and are turned off when PWM signals φ3B and φ4B are “L” level, respectively.

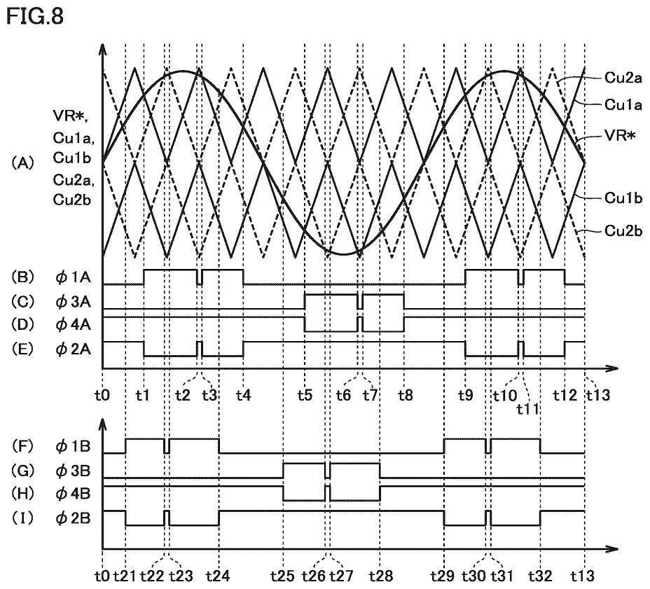

FIG. 8 is a time chart showing waveforms of voltage command value VR*, triangular wave signals Cu1a, Cu1b, Cu2a and Cu2b, and PWM signals φ1A to φ4A and φ1B to φ4B shown in FIG. 7. In FIG. 8, (A) shows waveforms of voltage command value VR* and triangular wave signals Cu1a, Cu1b, Cu2a and Cu2b, (B) to (E) show waveforms of PWM signals φ1A, φ3A, φ4A and φ2A, respectively, and (F) to (I) show waveforms of PWM signals φ1B, φ3B, φ4B and φ2B, respectively.

As shown in FIG. 8(A), voltage command value VR* is a sinusoidal wave signal of a commercial frequency. Voltage command value VR* is a voltage command value when Ep=En (i.e., a state in which a correction by balance control circuit 70 is not made) (VR*=VR0*).

The lowest value of triangular wave signals Cu1a and Cu2a is 0 V, and the highest value thereof is higher than a positive peak value of voltage command value VR*. The highest value of triangular wave signals Cu1b and Cu2b is 0 V, and the lowest value thereof is lower than a negative peak value of voltage command value VR*. Triangular wave signals Cu1a and Cu1b are signals of the same phase. Triangular wave signals Cu2a and Cu2b are signals of the same phase. Triangular wave signal Cu2a is shifted in phase by 180° relative to triangular wave signal Cu1a. Triangular wave signal Cu2b is shifted in phase by 180° relative to triangular wave signal Cu1b.

As shown in FIG. 8(A) and FIG. 8(B), when the level of triangular wave signal Cu1a is higher than voltage command value VR* (between times t0 and t1, t2 and t3, t4 and t9, . . . ), PWM signal φ1A is “L” level. Conversely, when the level of triangular wave signal Cu1a is lower than voltage command value VR* (between times t1 and t2, t3 and t4, . . . ), PWM signal φ1A is “H” level. As shown in FIG. 8(B) and FIG. 8(E), PWM signal φ2A is an inverted signal of PWM signal φ1A.

As shown in FIG. 8(A) and FIG. 8(C), when the level of triangular wave signal Cu1b is lower than voltage command value VR* (between times t0 and t5, t6 and t7, . . . ), PWM signal φ3A is “L” level. Conversely, when the level of triangular wave signal Cu1b is higher than voltage command value VR* (between times t5 and t6, t7 and t8, . . . ), PWM signal φ3A is “H” level. As shown in FIG. 8(C) and FIG. 8(D), PWM signal φ4A is an inverted signal of PWM signal φ3A.

As shown in FIG. 8(A) and FIG. 8(F), when the level of triangular wave signal Cu2a is higher than voltage command value VR* (between times t0 and t21, t22 and t23, t24 and t29, . . . ), PWM signal φ1B is “L” level. Conversely, when the level of triangular wave signal Cu2a is lower than voltage command value VR* (between times t21 and t22, t23 and t24, . . . ), PWM signal φ1B is “H” level. As shown in FIG. 8(F) and FIG. 8(I), PWM signal φ2B is an inverted signal of PWM signal φ1B.

As shown in FIG. 8(A) and FIG. 8(G), when the level of triangular wave signal Cu2b is lower than voltage command value VR* (between times t0 and t25, t26 and t27, . . . ), PWM signal φ3B is “L” level. Conversely, when the level of triangular wave signal Cu2b is higher than voltage command value VR* (between times t25 and t26, t27 and t28, . . . ), PWM signal φ3B is “H” level. As shown in FIG. 8(G) and FIG. 8(H), PWM signal φ4B is an inverted signal of PWM signal φ3B.

Although FIG. 8(A) to FIG. 8(I) show the waveforms of voltage command value VR* and signals Cu1a, Cu1b, Cu2a, Cu2b, φ1A to φ4A and φ1B to φ4B corresponding to the R phase, the same is also applied to the waveforms of the voltage command value and the signals corresponding to each of the S phase and the T phase. It is noted that the waveforms of the voltage command values and the signals corresponding to the R phase, the S phase and the T phase are shifted from each other by 120°.

In the first embodiment, in each phase arm, two three-level circuits 3A and 3B connected in parallel are driven in an interleaved manner. As shown in FIG. 8, triangular wave signals Cu1a and Cu1b, and triangular wave signals Cu2a and Cu2b shifted in phase relative to triangular wave signals Cula and Cu1b are prepared. The results of the comparisons between voltage command value VR* and triangular wave signals Cu1a and Cu1b are PWM signals φ1A to φ4A, and the results of the comparisons between voltage command value VR* and triangular wave signals Cu2a and Cu2b are PWM signals φ1B to φ4B.

By intentionally shifting the phases of PWM signals φ1A to φ4A from the phases of PWM signals φ1B to φ4B in this manner, ripples (current variations generated during switching) generated by each three-level circuit can cancel each other out.

Accordingly, ripple components included in a sum current of the output currents of three-level circuits 3A and 3B are reduced and an effective frequency of the ripple components is doubled, which can lead to a size reduction of AC input filter 2. In addition, the current is branched into three-level circuits 3A and 3B in each phase arm, and power loss per IGBT is therefore reduced, which can then facilitate the thermal design of the IGBT.

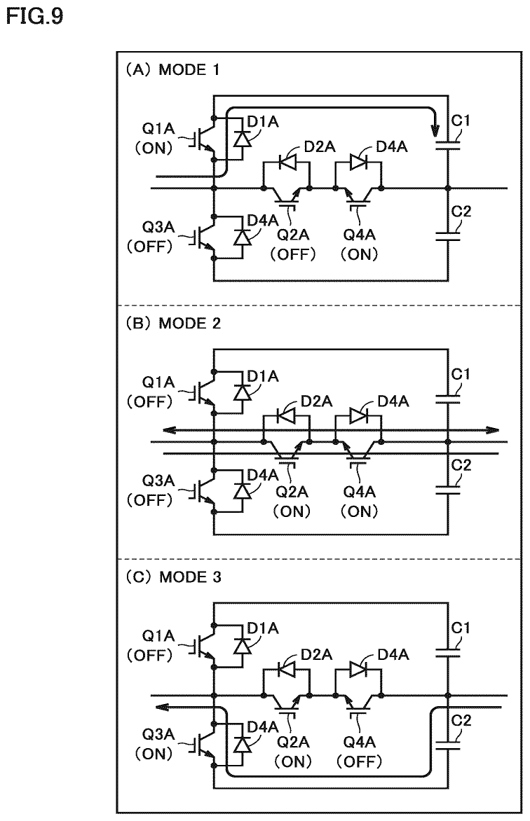

Here, it can be seen that a switching pattern of the IGBTs in each bridge circuit has three modes. FIG. 9 shows a switching pattern of the four IGBTs included in each bridge circuit. FIG. 9 shows an operation of bridge circuit 3A in each mode.

FIG. 9(A) shows a mode 1. In mode 1, IGBTs Q1A and Q4A are turned on, IGBTs Q2A and Q3A are turned off, and capacitor C1 on the positive side is charged or discharged. FIG. 9(B) shows a mode 2. In mode 2, IGBTs Q2A and Q4A are turned on, IGBTs Q1A and Q3A are turned off, and there is no significant difference in the power storage state between capacitor C1 on the positive side and capacitor C2 on the negative side. FIG. 9(C) shows a mode 3. In mode 3, IGBTs Q2A and Q3A are turned on, IGBTs Q1A and Q4A are turned off, and capacitor C2 on the negative side is charged or discharged. In FIG. 9(A) and FIG. 9(C), the arrow indicates a direction of current flow during charging. The current flows in an opposite direction to the arrow during discharging.

Returning to FIG. 8, when Ep<En, voltage command value VR* is obtained by adding voltage command value V1* to voltage command value VR0*. Voltage command value V1* is positive when Ep<En. By comparing in PWM circuit 72 whether voltage command value VR* is higher or lower than triangular wave signals Cu1a, Cu1b, Cu2a and Cu2b, the switching pattern of the four IGBTs included in each bridge circuit is determined. When Ep<En, the time of mode 1 (the charging time of capacitor C1) is longer, and the time of mode 3 (the charging time of capacitor C2) is shorter, as compared to when Ep=En. Therefore, ΔE=Ep−En decreases.

When Ep>En, voltage command value VR* is obtained by adding voltage command value V1* to voltage command value VR0*. Voltage command value V1* is negative when Ep>En. By comparing in PWM circuit 72 whether voltage command value VR* is higher or lower than triangular wave signals Cu1a, Cu1b, Cu2a and Cu2b, the switching pattern of the four IGBTs included in each bridge circuit is determined. When Ep>En, the time of mode 1 (the charging time of capacitor C1) is shorter, and the time of mode 3 (the charging time of capacitor C2) is longer, as compared to when Ep=En. Therefore, ΔE=Ep−En decreases.

As described above, first control circuit 53 generates PWM signals φ1A to φ4A and φ1B to φ4B such that three-phase AC voltages VR, VS and VT are in phase with three-phase AC currents IR, IS and IT, DC voltage VDC is equal to reference DC voltage VDCR, and DC voltage ΔE becomes zero. When power failure signal PC is “L” level which is the inactivation level (when commercial AC power supply 41 is sound), switching circuit 55 connects first control circuit 53 to converter 3. Thus, PWM signals φ1A to φ4A and φ1B to φ4B are provided to the gates of IGBTs Q1A to Q4A and Q1B to Q4B of R-phase arm 3R, respectively, through switching circuit 55.

### (Configuration of Second Control Circuit)

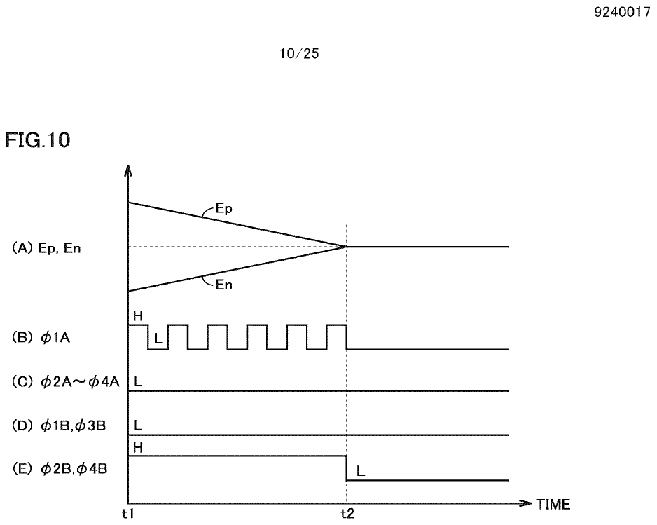

FIG. 10 is a time chart showing an operation of second control circuit 54 shown in FIG. 5. FIG. 10 shows control for one phase (e.g., R-phase arm 3R) of converter 3 when Ep>En. FIG. 10(A) shows waveforms of Ep and En. FIG. 10(B) to FIG. 10(E) show waveforms of PWM signals φ1A to φ4A and φ1B to φ4B generated by second control circuit 54.

When Ep>En (time t1), PWM signal φ1A is set to “H” level and “L” level at a prescribed frequency fc. PWM signals φ2A to φ4A, φ1B and φ3B are fixed to “L” level, and PWM signals φ2B and φ4B are fixed to “H” level.

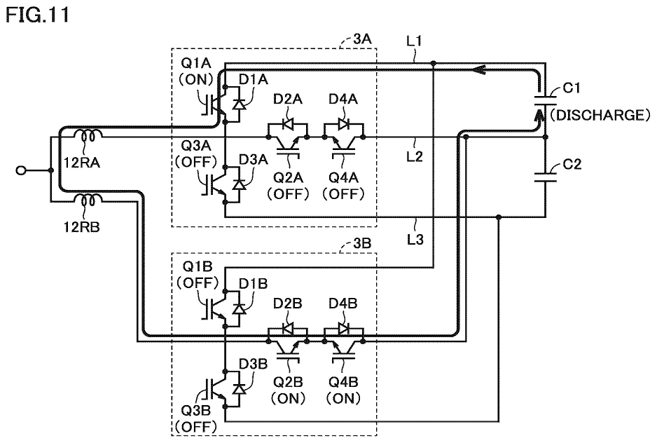

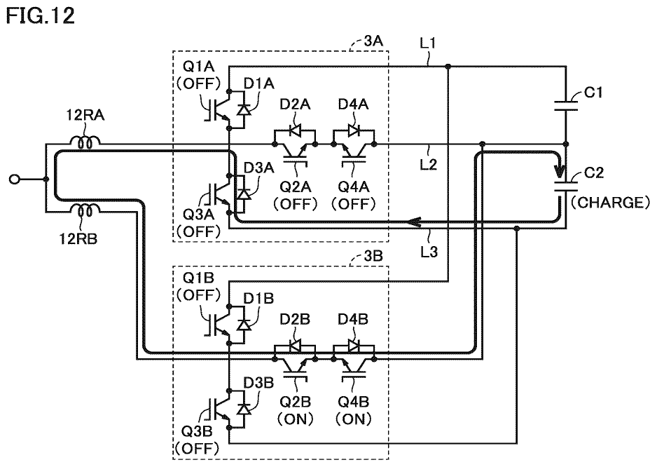

FIGS. 11 and 12 are each an equivalent circuit diagram showing an operation for one phase of converter 3 when Ep>En. As shown in FIG. 11, when PWM signal φ1A is set to “H” level and PWM signals φ2B and φ4B are set to “H” level, IGBT Q1A (first switch) is turned on and IGBTs Q2B and Q4B (fifth switch) are turned on. Thus, a current flows from the positive electrode of capacitor C1 to the negative electrode of capacitor C1 through DC line L1, IGBT Q1A, reactors 12RA and 12RB, IGBT Q2B, diode D4B, and DC line L2, as indicated by the arrows in FIG. 11. Thus, capacitor C1 is discharged, and terminal-to-terminal voltage Ep of capacitor C1 decreases. At this time, electromagnetic energy is stored in reactors 12RA and 12RB.

Then, when PWM signal φ1A is set to “L” level, IGBT Q1A (first switch) is turned off, as shown in FIG. 12. Thus, a current flows from reactor 12RA to reactor 12RA through reactor 12RB, IGBT Q2B, diode D4B, DC line L2, capacitor C2, DC line L3, and diode D3A, as indicated by the arrows in FIG. 12. At this time, the electromagnetic energy in reactors 12RA and 12RB is emitted, capacitor C2 is charged, and terminal-to-terminal voltage En of capacitor C2 increases.

When such an operation of setting PWM signal φ1A to “H” level and “L” level to turn on and off IGBT Q1A (first switch) is repeated, ΔE=Ep−En gradually decreases. When ΔE=0 (time t2), PWM signals φ1A, φ2B and φ4B are fixed to “L” level. That is, all of IGBTs Q1A to Q4A and Q1B to Q4B are turned off and the operation of converter 3 is stopped.

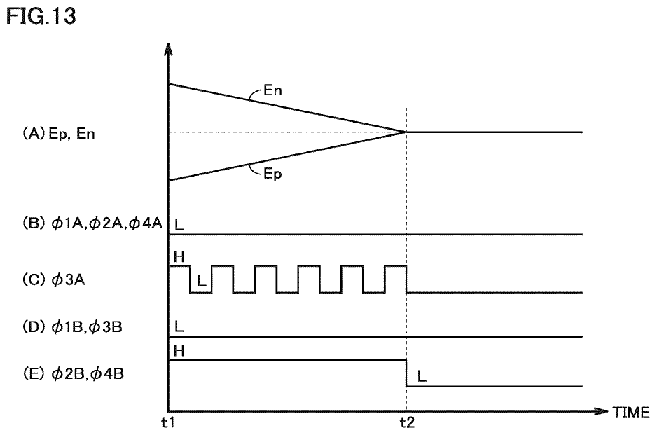

FIG. 13 is a time chart showing an operation of second control circuit 54 shown in FIG. 5. FIG. 13 shows control for one phase (e.g., R-phase arm 3R) of converter 3 when Ep<En. FIG. 13(A) shows waveforms of Ep and En. FIG. 13(B) to FIG. 13(E) show waveforms of PWM signals φ1A to φ4A and φ1B to φ4B generated by second control circuit 54.

When Ep<En (time t1), PWM signal φ3A is set to “H” level and “L” level at prescribed frequency fc. PWM signals φ1A, φ2A, φ4A, φ1B and φ3B are fixed to “L” level, and PWM signals φ2B and φ4B are fixed to “H” level.

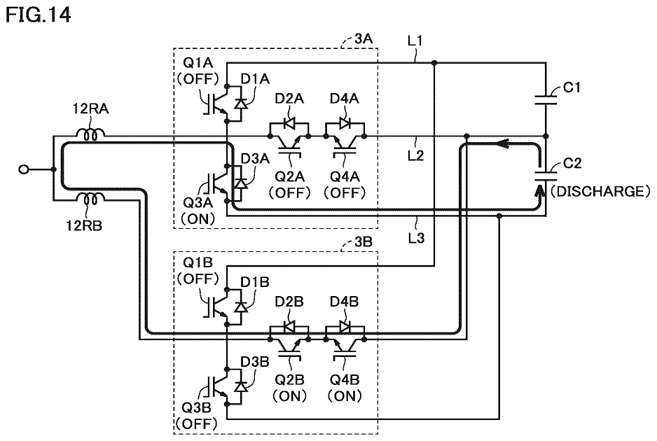

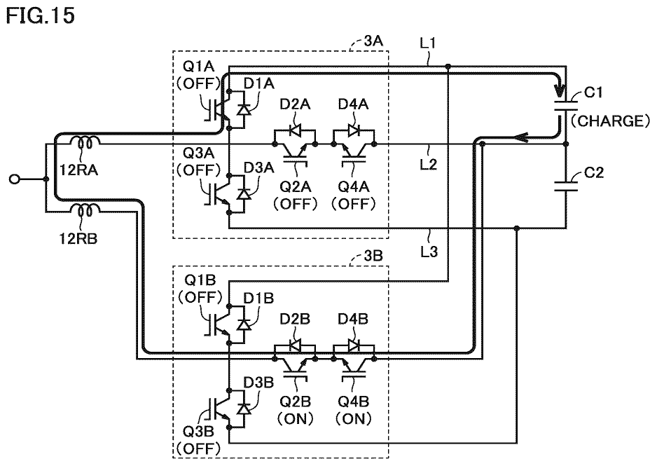

FIGS. 14 and 15 are each an equivalent circuit diagram showing an operation for one phase of converter 3 when Ep<En. As shown in FIG. 14, when PWM signal φ3A is set to “H” level and PWM signals φ2B and φ4B are set to “H” level, IGBT Q3A (third switch) is turned on and IGBTs Q2B and Q4B (fifth switch) are turned on. Thus, a current flows from the positive electrode of capacitor C2 to the negative electrode of capacitor C2 through DC line L2, IGBT Q4B, diode D2B, reactors 12RB and 12RA, IGBT Q3A, and DC line L3, as indicated by the arrows in FIG. 14. Thus, capacitor C2 is discharged, and terminal-to-terminal voltage En of capacitor C2 decreases. At this time, electromagnetic energy is stored in reactors 12RA and 12RB.

Then, when PWM signal φ3A is set to “L” level, IGBT Q3A (third switch) is turned off, as shown in FIG. 15. Thus, a current flows from reactor 12RB to reactor 12RA through reactor 12RA, diode D1A, DC line L1, capacitor C1, DC line L2, IGBT Q4B, diode D2B, and reactor 12RB, as indicated by the arrows in FIG. 15. At this time, the electromagnetic energy in reactors 12RA and 12RB is emitted, capacitor C1 is charged, and terminal-to-terminal voltage Ep of capacitor C1 increases.

When such an operation of setting PWM signal φ3A to “H” level and “L” level to turn on and off IGBT Q3A (third switch) is repeated, ΔE=Ep−En gradually decreases. When ΔE=0 (time t2), PWM signals φ3A, φ2B and φ4B are fixed to “L” level. That is, all of IGBTs Q1A to Q4A and Q1B to Q4B are turned off and the operation of converter 3 is stopped.

When power failure signal PC is “H” level which is the activation level (when commercial AC power supply 41 has a power failure), switching circuit 55 connects second control circuit 54 to converter 3. Thus, PWM signals φ1A to φ4A and φ1B to φ4B are provided to the gates of IGBTs Q1A to Q4A and Q1B to Q4B of R-phase arm 3R, respectively, through switching circuit 55.

### (Balance Control by Converter)

Next, balance control by converter 3 when commercial AC power supply 41 is sound is described. When commercial AC power supply 41 is sound, switching circuit 55 connects first control circuit 53 to converter 3.

When Ep<En, first control circuit 53 adds positive voltage command value V1* to voltage command values VR0*, VS0* and VT0* and generates voltage command values VR*, VS* and VT*, in order to achieve voltage balance between capacitors C1 and C2. When Ep>En, first control circuit 53 adds negative voltage command value V1* to voltage command values VR0*, VS0* and VT0* and generates voltage command values VR*, VS* and VT*, in order to achieve voltage balance between capacitors C1 and C2.

By comparing in PWM circuit 72 whether voltage command values VR*, VS* and VT* are higher or lower than triangular wave signals Cu1a, Cu1b, Cu2a and Cu2b, PWM signals φ1A to φ4A and φ1B to φ4B are generated. Capacitor C1 is charged during periods over which voltage command values VR*, VS* and VT* are positive. Capacitor C2 is charged during periods over which voltage command values VR*, VS* and VT* are negative.

When Ep<En, the charging time of capacitor C1 is longer than the charging time of capacitor C2 as compared to when Ep=En, and therefore, voltage Ep can be more increased than voltage En. Since voltage command value V1* is output to achieve Ep=En, the voltages of capacitors C1 and C2 match and balance between these voltages is achieved.

When Ep>En, the charging time of capacitor C2 is longer than the charging time of capacitor C1 as compared to when Ep=En, and therefore, voltage En can be more increased than voltage Ep. Since voltage command value V1* is output to achieve Ep=En, the voltages of capacitors C1 and C2 match and balance between these voltages is achieved.

Next, balance control by converter 3 when commercial AC power supply 41 has a power failure is described.

When Ep>En, second control circuit 54 performs an operation of turning on IGBTs Q2B and Q4B (fifth switch) of three-level circuit 3B and turning on and off IGBT Q1A (first switch) of three-level circuit 3A at prescribed frequency fc, as shown in FIG. 10, in order to achieve voltage balance between capacitors C1 and C2.

When IGBT Q1A is turned on, a current flows out of capacitor C1, terminal-to-terminal voltage Ep of capacitor C1 decreases, and electromagnetic energy is stored in reactors 12RA and 12RB, as shown in FIG. 11. When IGBT Q1A is turned off, the electromagnetic energy stored in reactors 12RA and 12RB is emitted, capacitor C2 is charged, and terminal-to-terminal voltage En of capacitor C2 increases, as shown in FIG. 12. By turning on and off IGBT Q1A at prescribed frequency fc, ΔE=Ep−En gradually decreases. When ΔE=0, IGBTs Q1A to Q4A and Q1B to Q4B are turned off and the operation of converter 3 is thus stopped.

When Ep<En, second control circuit 54 performs an operation of turning on IGBTs Q2B and Q4B (fifth switch) of three-level circuit 3B and turning on and off IGBT Q3A (third switch) of three-level circuit 3A at prescribed frequency fc, as shown in FIG. 13, in order to achieve voltage balance between capacitors C1 and C2.

When IGBT Q3A is turned on, a current flows out of capacitor C2, terminal-to-terminal voltage En of capacitor C2 decreases, and electromagnetic energy is stored in reactors 12RA and 12RB, as shown in FIG. 14. When IGBT Q3A is turned off, the electromagnetic energy stored in reactors 12RA and 12RB is emitted, capacitor C1 is charged, and terminal-to-terminal voltage Ep of capacitor C1 increases, as shown in FIG. 15. By turning on and off IGBT Q3A at prescribed frequency fc, ΔE=Ep−En gradually decreases. When ΔE=0, IGBTs Q1A to Q4A and Q1B to Q4B are turned off and the operation of converter 3 is thus stopped.

### (Configuration of Control Circuit)

Returning to FIG. 5, control circuit 80 controls DC voltage converter 6 based on power failure signal PC from power failure detector 33, the signal indicating battery voltage VB from voltage detector 36, the signal indicating battery current IB from current detector 37, and the signal indicating DC voltage VDC from adder 51.

Specifically, when power failure signal PC is “L” level which is the inactivation level (when commercial AC power supply 41 is sound), control circuit 80 controls DC voltage converter 6 such that battery current IB of a level corresponding to DC voltage VDC flows from capacitors C1 and C2 to battery B1 and battery voltage VB is equal to reference battery voltage VBR.

When power failure signal PC is “H” level which is the activation level (when commercial AC power supply 41 has a power failure), control circuit 80 controls DC voltage converter 6 such that battery current IB of a level corresponding to battery voltage VB flows from battery B1 to capacitors C1 and C2 and DC voltage VDC is equal to reference DC voltage VDCR. That is, the difference from the balance control described in PTLs 1 and 2 is that balance control by DC voltage converter 6 is not performed when commercial AC power supply 41 has a power failure.

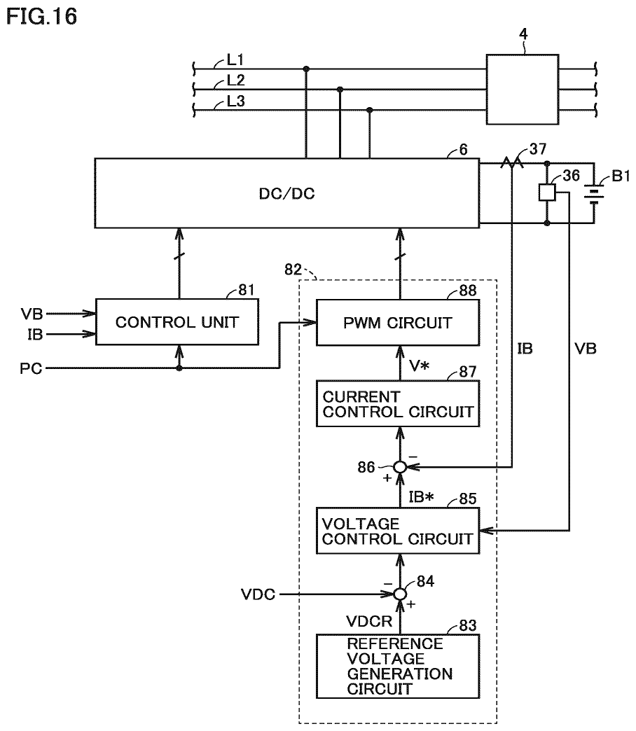

FIG. 16 is a block diagram showing a configuration of control circuit 80 shown in FIG. 5. As shown in FIG. 16, control circuit 80 includes control units 81 and 82.

When power failure signal PC is “L” level which is the inactivation level (when commercial AC power supply 41 is sound), control unit 81 is activated and controls DC voltage converter 6 such that current IB of the level corresponding to DC voltage VDC flows from capacitors C1 and C2 to battery B1 and terminal-to-terminal voltage VB of battery B1 is equal to reference battery voltage VBR.

When power failure signal PC is “H” level which is the activation level (when commercial AC power supply 41 has a power failure), control unit 82 is activated and controls DC voltage converter 6 such that current IB of the level corresponding to terminal-to-terminal voltage VB of battery B1 flows from battery B1 to capacitors C1 and C2 and DC voltage VDC is equal to reference DC voltage VDCR. Specifically, control unit 82 includes a reference voltage generation circuit 83, subtractors 84 and 86, a voltage control circuit 85, a current control circuit 87, and a PWM circuit 88.

Reference voltage generation circuit 83 generates reference DC voltage VDCR. Subtractor 84 calculates voltage AVDC that is the difference between reference DC voltage VDCR and DC voltage VDC detected by adder 51.

Voltage control circuit 85 calculates a current command value IB* of a level corresponding to voltage AVDC based on terminal-to-terminal voltage VB of battery B1 detected by voltage detector 36. Voltage control circuit 85 calculates current command value IB* by, for example, proportional operation or proportional integral operation of AVDC.

Subtractor 86 determines a difference ΔIB=IB*−IB between current command value IB* generated by voltage control circuit 85 and current value IB of battery B1 detected by current detector 37. Current control circuit 87 generates a voltage command value V* based on difference ΔIB between current command value IB* and current value IB.

When power failure signal PC is “H” level which is the activation level (when commercial AC power supply 41 has a power failure), PWM circuit 88 is activated and outputs a signal for driving the four IGBTs included in semiconductor switch 21 based on voltage command value V*. DC voltage converter 6 is controlled by the signal from PWM circuit 88, and supplies DC power in battery B1 to inverter 4.

When power failure signal PC is “L” level which is the inactivation level (when commercial AC power supply 41 is sound), PWM circuit 88 is inactivated and does not perform PWM control of DC voltage converter 6. When commercial AC power supply 41 is sound, DC voltage converter 6 is controlled by control unit 81 and stores DC power in battery B1.

### <Operation of Uninterruptible Power Supply Apparatus>

Next, an operation of uninterruptible power supply apparatus 100 according to the first embodiment is described.

When commercial AC power supply 41 is sound, switch 1 is turned on, and three-phase AC power from commercial AC power supply 41 is supplied to converter 3 through switch 1 and AC input filter 2 and is converted into DC power by converter 3. The DC power is stored in battery B1 by DC voltage converter 6, and is converted into three-phase AC power by inverter 4. The three-phase AC power generated by inverter 4 is supplied to load 42 through AC output filter 5, and drives load 42.

At this time, converter 3 is controlled by first control circuit 53 such that DC voltage VDC=Ep+En that is the sum of terminal-to-terminal voltages Ep and En of capacitors C1 and C2 is equal to reference DC voltage VDCR, and DC voltage ΔE=Ep−En that is the difference between terminal-to-terminal voltages Ep and En of capacitors C1 and C2 becomes zero.

When commercial AC power supply 41 has a power failure, basically, switch 1 is turned off, the operation of converter 3 is stopped, and DC power in battery B1 is supplied to inverter 4 through DC voltage converter 6 and is converted into three-phase AC power of a commercial frequency by inverter 4. The three-phase AC power generated by inverter 4 is supplied to load 42 through AC output filter 5.

At this time, DC voltage converter 6 is controlled by control unit 82 such that DC voltage VDC=Ep+En that is the sum of terminal-to-terminal voltages Ep and En of capacitors C1 and C2 is equal to reference DC voltage VDCR.

When terminal-to-terminal voltages Ep and En of capacitors C1 and C2 become imbalanced, however, converter 3 is activated. Converter 3 discharges capacitor C1 and charges capacitor C2 when Ep>En, and discharges capacitor C2 and charges capacitor C1 when Ep<En, to reduce DC voltage ΔE=Ep−En that is the difference between terminal-to-terminal voltages Ep and En of capacitors C1 and C2. When DC voltage ΔE becomes zero, the operation of converter 3 is stopped.

### Advantageous Effects of First Embodiment

As described above, in the first embodiment, when commercial AC power supply 41 has a power failure, switch 1 is turned off to electrically disconnect commercial AC power supply 41 from AC input filter 2, and converter 3 is controlled such that DC voltage ΔE=Ep−En that is the difference between terminal-to-terminal voltages Ep and En of capacitors C1 and C2 is eliminated, to reduce DC voltage ΔE. Therefore, even when a load current is small, imbalance between terminal-to-terminal voltages Ep and En of capacitors C1 and C2 when commercial AC power supply 41 has a power failure can be eliminated.

Furthermore, in the first embodiment, each phase arm of converter 3 is implemented by three-level circuits 3A and 3B connected in parallel, and when commercial AC power supply 41 has a power failure, three-level circuits 3A and 3B are operated to discharge or charge capacitors C1 and C2, to thereby reduce DC voltage ΔE. At this time, the discharging and charging of capacitors C1 and C2 is achieved by accumulation of electromagnetic energy in reactor 12 of AC input filter 2 and emission of the electromagnetic energy, respectively. According to the first embodiment, capacitors C1 and C2 can be discharged or charged without using capacitor 11 of AC input filter 2 as a power buffer. Therefore, the balance control by converter 3 when commercial AC power supply 41 has a power failure can be simplified.

In addition, the first embodiment can remove the need for the operation for discharging capacitor 11 of AC input filter 2 in order to discharge or charge capacitors C1 and C2, thereby quickly eliminating imbalance between terminal-to-terminal voltages Ep and En of capacitors C1 and C2 when commercial AC power supply 41 has a power failure.

### Second Embodiment

In the first embodiment, a configuration has been described in which three-level circuits 3A and 3B of each phase arm of converter 3 are operated to eliminate imbalance between terminal-to-terminal voltages Ep and En of capacitors C1 and C2.

According to this configuration, imbalance between terminal-to-terminal voltages Ep and En of capacitors C1 and C2 can be eliminated in a short time when commercial AC power supply 41 has a power failure. On the other hand, loss occurs in each phase arm of converter 3. The loss in each phase arm specifically refers to conduction loss (loss in the IGBT and the diode when they are energized) and switching loss in the IGBT. This raises a concern that operation efficiency of uninterruptible power supply apparatus 100 might be decreased when commercial AC power supply 41 has a power failure.

To address such a concern, a second embodiment employs a configuration in which the number of phase arms of converter 3 to be operated when commercial AC power supply 41 has a power failure is changed depending on an absolute value of DC voltage ΔE that is the difference between terminal-to-terminal voltages Ep and En of capacitors C1 and C2.

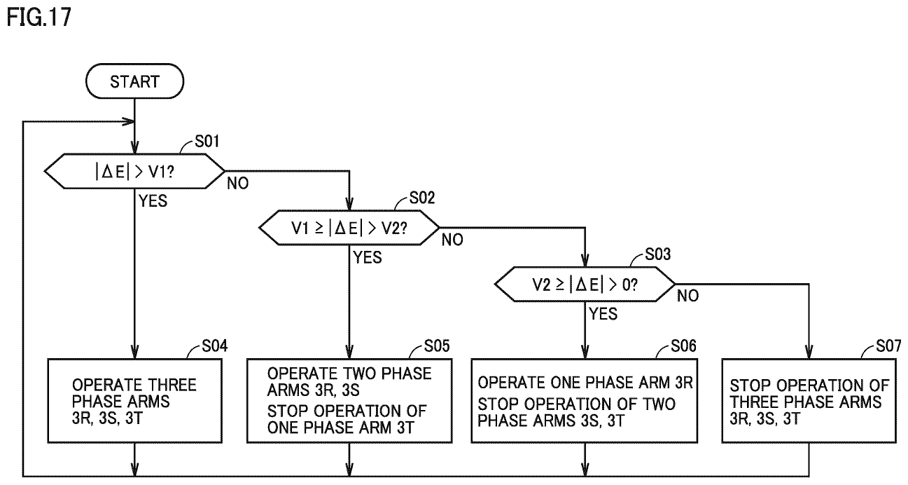

FIG. 17 is a flowchart showing a modification of the balance control by converter 3 when commercial AC power supply 41 has a power failure. The flowchart shown in FIG. 17 is performed by second control circuit 54 shown in FIG. 5.

As shown in FIG. 17, first, in step S01, second control circuit 54 compares an absolute value (hereinafter denoted as |ΔE|) of DC voltage ΔE=Ep−En that is the difference between terminal-to-terminal voltages Ep and En of capacitors C1 and C2 with a predetermined first threshold voltage V1. First threshold voltage V1 is a positive voltage.

When the absolute value of ΔE is greater than first threshold voltage V1 (YES in S01), in step S04, second control circuit 54 operates R-phase arm 3R, S-phase arm 3S and T-phase arm 3T. In S04, three-level circuits 3A and 3B of each of three phase arms 3R, 3T and 3S are controlled such that DC voltage ΔE is eliminated.

When the absolute value of ΔE is equal to or smaller than first threshold voltage V1 (NO in S01), in step S02, second control circuit 54 compares the absolute value of ΔE with a predetermined second threshold voltage V2. Second threshold voltage V2 is a positive voltage lower than first threshold voltage V1.

When the absolute value of ΔE is equal to or smaller than first threshold voltage V1 and greater than second threshold voltage V2 (YES in S02), in step S05, second control circuit 54 operates two phase arms (e.g., R-phase arm 3R and S-phase arm 3S) of the three phase arms and stops the operation of the remaining one phase arm (e.g., T-phase arm 3T). In S05, three-level circuits 3A and 3B of each of R-phase arm 3R and S-phase arm 3S are controlled such that DC voltage ΔE is eliminated.

When the absolute value of ΔE is equal to or smaller than second threshold voltage V2 (NO in S02), in step S03, second control circuit 54 compares the absolute value of ΔE with zero. When the absolute value of ΔE is equal to or smaller than second threshold voltage V2 and greater than zero (YES in S02), in step S06, second control circuit 54 operates one phase arm (e.g., R-phase arm 3R) of the three phase arms and stops the operation of the remaining two phase arms (e.g., S-phase arm 3S and T-phase arm 3T). In S06, three-level circuits 3A and 3B of R-phase arm 3R are controlled such that DC voltage ΔE is eliminated.

When the absolute value of ΔE is zero (NO in S03), in step S07, second control circuit 54 stops the operation of three phase arms 3R, 3S and 3T.

As described above, according to the second embodiment, when the absolute value of DC voltage ΔE exceeds first threshold voltage V1, three phase arms 3R, 3S and 3T of converter 3 can be operated to thereby quickly reduce DC voltage ΔE=Ep−En. Then, as the absolute value of DC voltage ΔE decreases, the number of phase arms to be operated can be reduced to thereby reduce the loss in converter 3, which can lead to enhanced operation efficiency of uninterruptible power supply apparatus 100 when commercial AC power supply 41 has a power failure.

### Third Embodiment

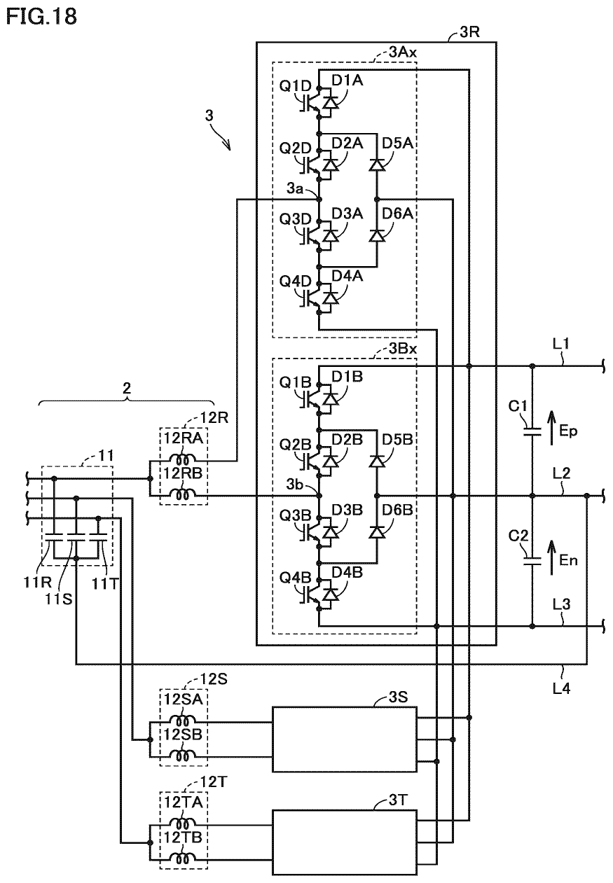

FIG. 18 is a circuit diagram showing a main part of an uninterruptible power supply apparatus according to a third embodiment, which is shown as compared with FIG. 3. As shown in FIG. 18, the third embodiment is different from the first embodiment in that each of phase arms 3R, 3S and 3T of converter 3 is implemented by three-level circuits 3Ax and 3Bx. Since each of phase arms 3R, 3S and 3T of converter 3 has the same circuit configuration, the circuit configuration of R-phase arm 3R is representatively described.

Three-level circuit 3Ax includes IGBTs Q1A to Q4A and diodes D1A to D6A. IGBTs Q1A to Q4A are connected in series between DC lines L1 and L3. Diodes D1A to D4A are connected in anti-parallel to IGBTs Q1A to Q4A, respectively. Diode D5A is connected to a connection point between IGBTs Q1A and Q2A and DC line L2. Diode D6A is connected to a connection point between IGBTs Q3A and Q4A and DC line L2.

Diodes D1A to D4A function as free-wheeling diodes, and diodes D5A and D6A function as clamp diodes. Input node 3a of three-level circuit 3Ax is connected to the second terminal of reactor 12RA, and is connected to a connection point between IGBTs Q2A and Q3A.

Three-level circuit 3Ax corresponds to an example of “first multi-level circuit.” IGBTs Q1A and Q2A and diodes D1A and D2A constitute a “first switch,” IGBTs Q2A and Q3A and diodes D2A, D3A, D5A and D6A constitute a “second switch,” and IGBTs Q3A and Q4A and diodes D3A and D4A constitute a “third switch.”

Three-level circuit 3Bx includes IGBTs Q1B to Q4B and diodes D1B to D6B. IGBTs Q1B to Q4B are connected in series between DC lines L1 and L3. Diodes D1B to D4B are connected in anti-parallel to IGBTs Q1B to Q4B, respectively.

Diode D5B is connected to a connection point between IGBTs Q1B and Q2B and DC line L2. Diode D6B is connected to a connection point between IGBTs Q3B and Q4B and DC line L2.

Diodes D1B to D4B function as free-wheeling diodes, and diodes D5B and D6B function as clamp diodes. Input node 3b of three-level circuit 3Bx is connected to the second terminal of reactor 12RB, and is connected to a connection point between IGBTs Q2B and Q3B.

Three-level circuit 3Bx corresponds to an example of “second multi-level circuit.” IGBTs Q1B and Q2B and diodes D1B and D2B constitute a “fourth switch,” IGBTs Q2B and Q3B and diodes D2B, D3B, D5B and D6B constitute a “fifth switch,” and IGBTs Q3B and Q4B and diodes D3B and D4B constitute a “sixth switch.”

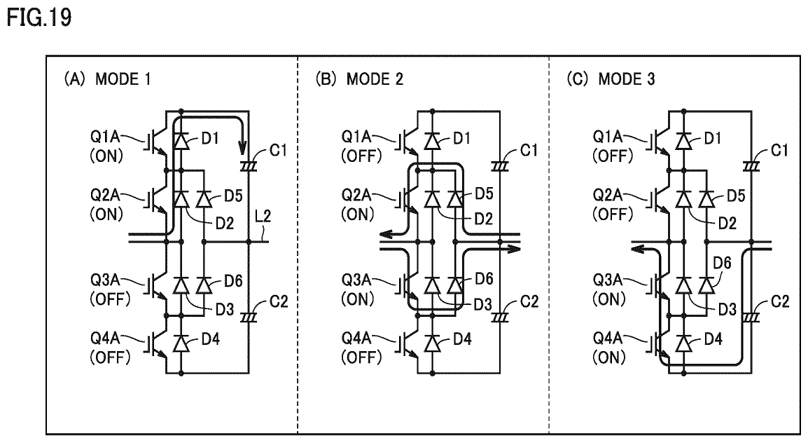

A switching pattern of the IGBTs in each bridge circuit has three modes. FIG. 19 shows a switching pattern of the four IGBTs included in each bridge circuit. FIG. 19 shows an operation of bridge circuit 3Ax in each mode.

FIG. 19(A) shows a mode 1. In mode 1, IGBTs Q1A and Q2A are turned on, IGBTs Q3A and Q4A are turned off, and capacitor C1 on the positive side is charged or discharged. FIG. 19(B) shows a mode 2. In mode 2, IGBTs Q2A and Q3A are turned on, IGBTs Q1A and Q4A are turned off, and there is no significant difference in the power storage state between capacitor C1 on the positive side and capacitor C2 on the negative side. FIG. 19(C) shows a mode 3. In mode 3, IGBTs Q3A and Q4A are turned on, IGBTs Q1A and Q2A are turned off, and capacitor C2 on the negative side is charged or discharged. In FIG. 19(A) and FIG. 19(C), the arrow indicates a direction of current flow during charging. The current flows in an opposite direction to the arrow during discharging.

In the third embodiment, as in the first embodiment, first control circuit 53 generates PWM signals φ1A to φ4A and φ1B to φ4B such that three-phase AC voltages VR, VS and VT are in phase with three-phase AC currents IR, IS and IT, DC voltage VDC that is the sum of terminal-to-terminal voltages Ep and En of capacitors C1 and C2 is equal to reference DC voltage VDCR, and DC voltage ΔE that is the difference between terminal-to-terminal voltages Ep and En of capacitors C1 and C2 becomes zero.

When power failure signal PC is “L” level which is the inactivation level (when commercial AC power supply 41 is sound), switching circuit 55 connects first control circuit 53 to converter 3. Thus, PWM signals φ1A to φ4A and φ1B to φ4B are provided to the gates of IGBTs Q1A to Q4A and Q1B to Q4B of R-phase arm 3R, respectively, through switching circuit 55. In each of phase arms 3R, 3S and 3T of converter 3, three-level circuits 3Ax and 3Bx connected in parallel are driven in an interleaved manner. Thus, ripples generated by each three-level circuit can cancel each other out, and therefore, the same advantageous effects as those in the first embodiment can be provided.

In the third embodiment, as in the first embodiment, second control circuit 54 controls converter 3 such that DC voltage ΔE becomes zero based on the signal indicating DC voltage ΔE from subtractor 52.

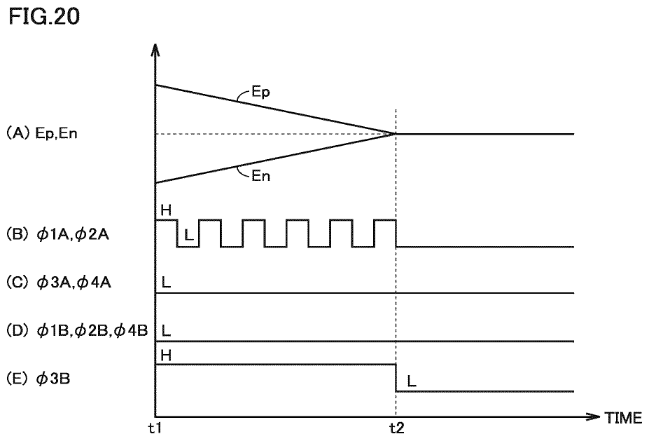

FIG. 20 is a time chart showing an operation of second control circuit 54. FIG. 20 shows control for one phase (e.g., R-phase arm 3R) of converter 3 when Ep>En. FIG. 20(A) shows waveforms of Ep and En. FIG. 20(B) to FIG. 20(E) show waveforms of PWM signals φ1A to φ4A and φ1B to φ4B generated by second control circuit 54.

When Ep>En (time t1), PWM signals φ1A and φ2A are set to “H” level and “L” level at prescribed frequency fc. PWM signals φ3A, φ4A, φ1B, φ2B and φ4B are fixed to “L” level, and PWM signal φ3B is fixed to “H” level.

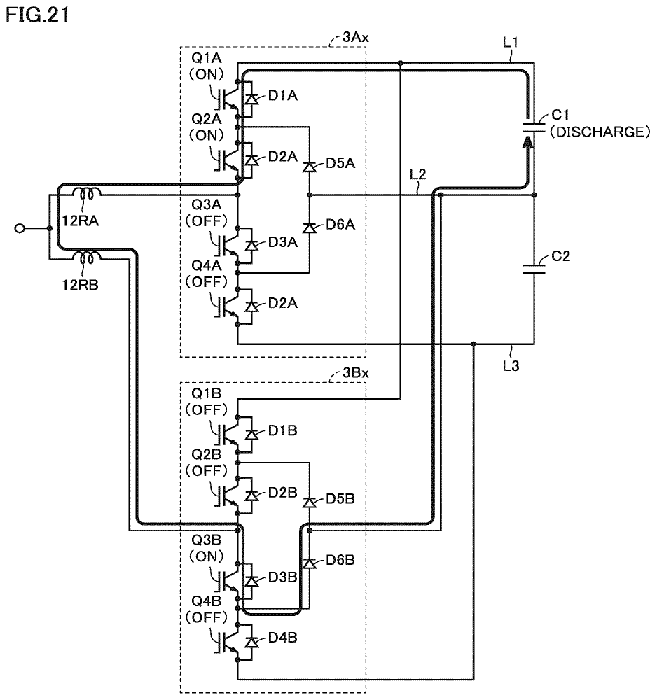

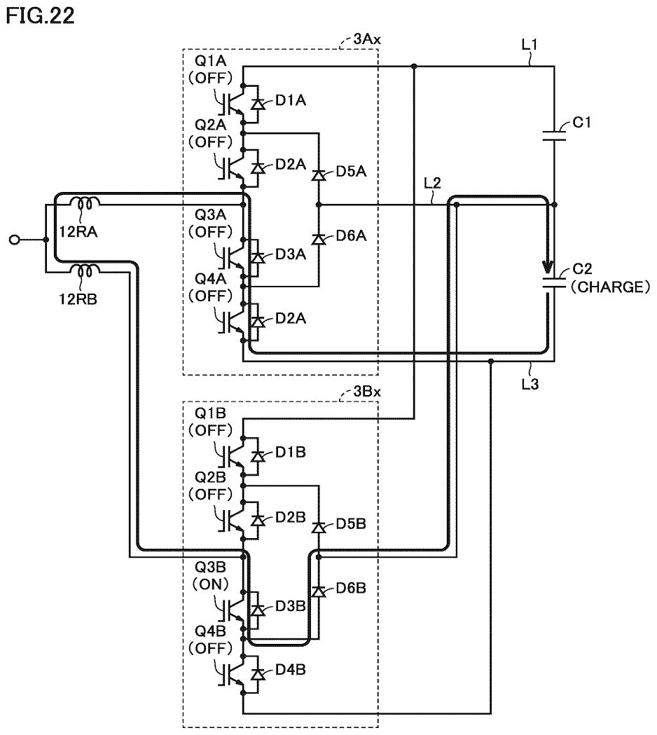

FIGS. 21 and 22 are each an equivalent circuit diagram showing an operation for one phase of converter 3 when Ep>En. As shown in FIG. 21, when PWM signals φ1A and φ2A are set to “H” level and PWM signal φ3B is set to “H” level, IGBTs Q1A and Q2A (first switch) are turned on and IGBT Q3B (fifth switch) is turned on. Thus, a current flows from the positive electrode of capacitor C1 to the negative electrode of capacitor C1 through DC line L1, IGBTs Q1A and Q2A, reactors 12RA and 12RB, IGBT Q3B, diode D6B, and DC line L2, as indicated by the arrow in FIG. 21. Thus, capacitor C1 is discharged, and terminal-to-terminal voltage Ep of capacitor C1 decreases. At this time, electromagnetic energy is stored in reactors 12RA and 12RB.

Then, when PWM signals φ1A and φ2A are set to “L” level, IGBTs Q1A and Q2A (first switch) are turned off, as shown in FIG. 22. Thus, a current flows from reactor 12RA to reactor 12RA through reactor 12RB, IGBT Q3B, diode D6B, DC line L2, capacitor C2, DC line L3, and diodes D2A and D3A, as indicated by the arrow in FIG. 22. At this time, the electromagnetic energy in reactors 12RA and 12RB is emitted, capacitor C2 is charged, and terminal-to-terminal voltage En of capacitor C2 increases.

When such an operation of setting PWM signals φ1A and φ2A to “H” level and “L” level to turn on and off IGBTs Q1A and Q2A (first switch) is repeated, ΔE=Ep−En gradually decreases. When ΔE=0 (time t2), PWM signals φ1A, φ2A and φ3B are fixed to “L” level. That is, all of IGBTs Q1A to Q4A and Q1B to Q4B are turned off and the operation of converter 3 is stopped.

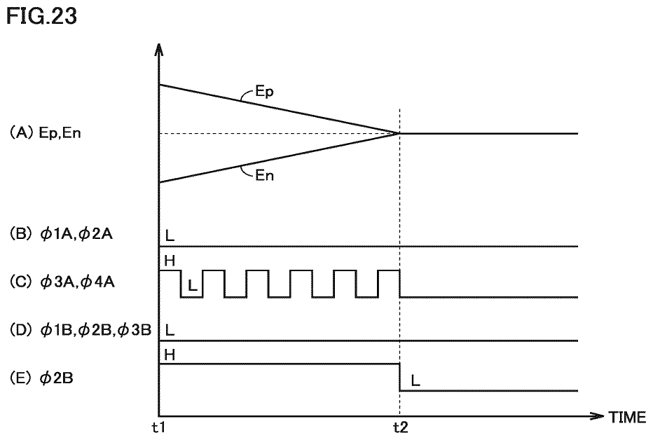

FIG. 23 is a time chart showing an operation of second control circuit 54. FIG. 23 shows control for one phase (e.g., R-phase arm 3R) of converter 3 when Ep<En. FIG. 23(A) shows waveforms of Ep and En. FIG. 23(B) to FIG. 23(E) show waveforms of PWM signals φ1A to φ4A and φ1B to φ4B generated by second control circuit 54.

When Ep<En (time t1), PWM signals φ3A and φ4A are set to “H” level and “L” level at prescribed frequency fc. PWM signals φ1A, φ2A, φ1B and φ3B are fixed to “L” level, and PWM signal φ2B is fixed to “H” level.

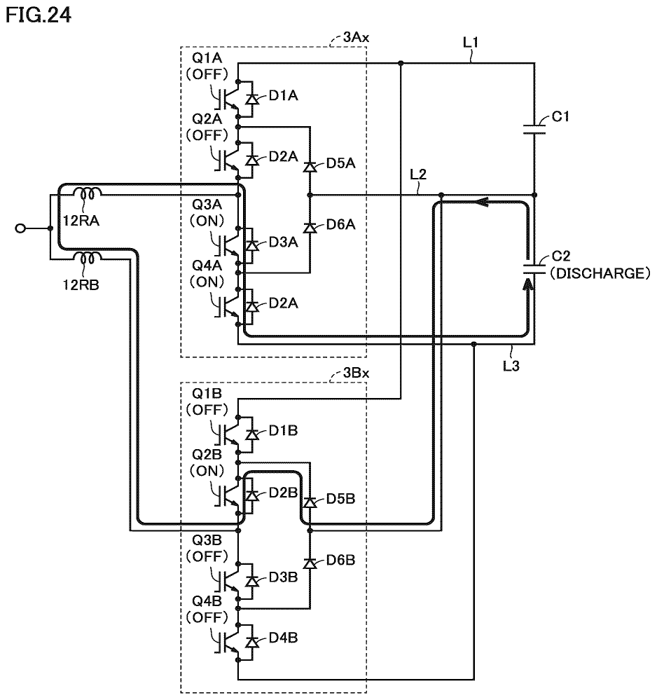

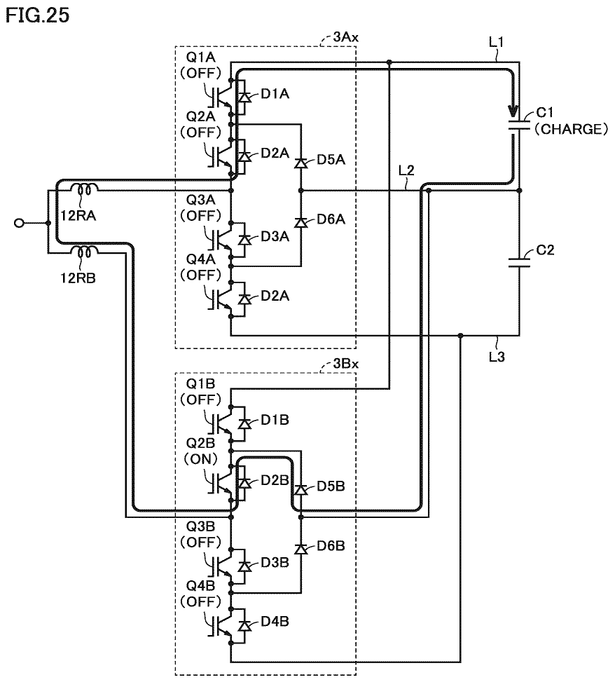

FIGS. 24 and 25 are each an equivalent circuit diagram showing an operation for one phase of converter 3 when Ep<En. As shown in FIG. 24, when PWM signals φ3A and φ4A are set to “H” level and PWM signal φ2B is set to “H” level, IGBTs Q3A and Q4A (third switch) are turned on and IGBT Q2B (fifth switch) is turned on. Thus, a current flows from the positive electrode of capacitor C2 to the negative electrode of capacitor C2 through DC line L2, diode D5B, IGBT Q2B, reactors 12RB and 12RA, IGBTs Q3A and Q4A, and DC line L3, as indicated by the arrows in FIG. 24. Thus, capacitor C2 is discharged, and terminal-to-terminal voltage En of capacitor C2 decreases. At this time, electromagnetic energy is stored in reactors 12RA and 12RB.

Then, when PWM signals φ3A and φ4A are set to “L” level, IGBTs Q3A and Q4A (third switch) are turned off, as shown in FIG. 25. Thus, a current flows from reactor 12RB to reactor 12RA through reactor 12RA, diodes D2A and D1A, DC line L1, capacitor C1, DC line L2, diode D5B, IGBT Q2B, and reactor 12RB, as indicated by the arrow in FIG. 25. At this time, the electromagnetic energy in reactors 12RA and 12RB is emitted, capacitor C1 is charged, and terminal-to-terminal voltage Ep of capacitor C1 increases.

When such an operation of setting PWM signals φ3A and φ4A to “H” level and “L” level to turn on and off IGBTs Q3A and Q4A (third switch) is repeated, ΔE=Ep−En gradually decreases. When ΔE=0 (time t2), PWM signals φ3A, φ2B and φ4B are fixed to “L” level. That is, all of IGBTs Q1A to Q4A and Q1B to Q4B are turned off and the operation of converter 3 is stopped.

When power failure signal PC is “H” level which is the activation level (when commercial AC power supply 41 has a power failure), switching circuit 55 connects second control circuit 54 to converter 3. Thus, PWM signals φ1A to φ4A and φ1B to φ4B are provided to the gates of IGBTs Q1A to Q4A and Q1B to Q4B of R-phase arm 3R, respectively, through switching circuit 55.

### (Balance Control by Converter)

Balance control by converter 3 when commercial AC power supply 41 is sound is the same as that described in the first embodiment. That is, switching circuit 55 connects first control circuit 53 to converter 3. When Ep<En, first control circuit 53 adds positive voltage command value V1* to voltage command values VR0*, VS0* and VT0* and generates voltage command values VR*, VS* and VT*. When Ep>En, first control circuit 53 adds negative voltage command value V1* to voltage command values VR0*, VS0* and VT0* and generates voltage command values VR*, VS* and VT*. PWM circuit 72 compares voltage command values VR*, VS* and VT* with triangular wave signals Cu1a, Cu1b, Cu2a and Cu2b to determine which is higher, to thereby generate PWM signals φ1A to φ4A and φ1B to φ4B. PWM circuit 72 provides generated PWM signals φ1A to φ4A and φ1B to φ4B to the gates of IGBTs Q1A to Q4A and Q1B to Q4B of three-level circuits 3Ax and 3Bx of each of phase arms 3R, 3S and 3T through switching circuit 55.

Next, balance control by converter 3 when commercial AC power supply 41 has a power failure is described.

When Ep>En, second control circuit 54 performs an operation of turning on IGBT Q3B of three-level circuit 3Bx and turning on and off IGBTs Q1A and Q2A of three-level circuit 3Ax at prescribed frequency fc, as shown in FIG. 20, in order to achieve voltage balance between capacitors C1 and C2.

When IGBTs Q1A and Q2A are turned on, a current flows out of capacitor C1, terminal-to-terminal voltage Ep of capacitor C1 decreases, and electromagnetic energy is stored in reactors 12RA and 12RB, as shown in FIG. 21. When IGBTs Q1A and Q2A are turned off, the electromagnetic energy stored in reactors 12RA and 12RB is emitted, capacitor C2 is charged, and terminal-to-terminal voltage En of capacitor C2 increases, as shown in FIG. 22. By turning on and off IGBTs Q1A and Q2A at prescribed frequency fc, ΔE=Ep−En gradually decreases. When ΔE=0, IGBTs Q1A to Q4A and Q1B to Q4B are turned off and the operation of converter 3 is thus stopped.

When Ep<En, second control circuit 54 performs an operation of turning on IGBT Q2B of three-level circuit 3Bx and turning on and off IGBTs Q3A and Q4A of three-level circuit 3Ax at prescribed frequency fc, as shown in FIG. 23, in order to achieve voltage balance between capacitors C1 and C2.

When IGBTs Q3A and Q4A are turned on, a current flows out of capacitor C2, terminal-to-terminal voltage En of capacitor C2 decreases, and electromagnetic energy is stored in reactors 12RA and 12RB, as shown in FIG. 24. When IGBTs Q3A and Q4A are turned off, the electromagnetic energy stored in reactors 12RA and 12RB is emitted, capacitor C1 is charged, and terminal-to-terminal voltage Ep of capacitor C1 increases, as shown in FIG. 25. By turning on and off IGBTs Q3A and Q4A at prescribed frequency fc, ΔE=Ep−En gradually decreases. When ΔE=0, IGBTs Q1A to Q4A and Q1B to Q4B are turned off and the operation of converter 3 is thus stopped.

In the third embodiment, as in the first embodiment, when commercial AC power supply 41 has a power failure, switch 1 is turned off to electrically disconnect commercial AC power supply 41 from AC input filter 2, and converter 3 is controlled such that DC voltage ΔE=Ep−En that is the difference between terminal-to-terminal voltages Ep and En of capacitors C1 and C2 is eliminated, to reduce DC voltage ΔE. When commercial AC power supply 41 has a power failure, each of phase arms 3R, 3S and 3T of converter 3 is implemented by two three-level circuits 3Ax and 3Bx connected in parallel, and three-level circuits 3Ax and 3Bx are operated to discharge or charge capacitors C1 and C2. Therefore, the same advantageous effects as those in the first embodiment can be provided in the third embodiment as well.

Furthermore, by applying the configuration in which the number of phase arms of converter 3 to be operated when commercial AC power supply 41 has a power failure is changed depending on the absolute value of DC voltage ΔE, as described in the second embodiment, to the third embodiment, the loss in converter 3 can be reduced while the absolute value of DC voltage ΔE is quickly reduced.

### Other Configuration Examples

Although a configuration in which each phase arm of converter 3 includes two three-level circuits 3A and 3B has been described in each of the first to third embodiments above, each phase arm of converter 3 may include three or more three-level circuits. In this case, when commercial AC power supply 41 is sound, the three or more three-level circuits can be driven in an interleaved manner. When commercial AC power supply 41 has a power failure, the three or more three-level circuits can be operated to thereby discharge or charge capacitors C1 and C2.

Although an uninterruptible power supply apparatus applicable to a three-phase, four-wire system AC power supply and load has been described in the present embodiment, the present disclosure is also applicable to a three-phase, three-wire system AC power supply and load. In addition, the AC power supply and the load are not limited to those of three phases, and a single-phase AC power supply or load may be employed.

It should be understood that the embodiments disclosed herein are illustrative and non-restrictive in every respect. The scope of the present disclosure is defined by the terms of the claims, rather than the description above, and is intended to include any modifications within the meaning and scope equivalent to the terms of the claims.

### Reference Signs List

1 switch; 2 AC input filter; 3 converter; 3R R-phase arm; 3S S-phase arm; 3T T-phase arm; 4 inverter; 5 AC output filter; 6 DC voltage converter; 10 controller; 11, 11R, 11S, 11T, 19, 19U, 19V, 19W, C1, C2 capacitor; 12, 12R, 12RA, 12RB, 12S, 12T, 18, 18U, 18V, 18W, 22, 22P, 22N reactor; 21 semiconductor switch; 31, 34 to 36 voltage detector; 32, 32R, 32S, 32T, 37 current detector; 33 power failure detector; 41 commercial AC power supply; 42 load; 51, 68A to 68C, 71A to 71C adder; 52, 62, 66A to 66C, 84, 86 subtractor; 53 first control circuit; 54 second control circuit; 55 switching circuit; 60 voltage command generation circuit; 61, 83 reference voltage generation circuit; 63 DC voltage control circuit; 64 sinusoidal wave generation circuit; 65A to 65C multiplier; 67, 87 current control circuit; 70 balance control circuit; 72, 88 PWM circuit; 80 control circuit; 85 voltage control circuit; 90 oscillator; 91 to 94 triangular wave generator; 95 to 98 comparator; 100 uninterruptible power supply apparatus; 102 CPU; 104 memory; 106 I/O circuit; 108 bus; 110, 112, 114, 116 buffer; 111, 113, 115, 117 NOT circuit; B1 battery; L1 to L3 DC line; Cu1a, Cu1b, Cu2a, Cu2b triangular wave signal.

1. An uninterruptible power supply apparatus comprising:
a first DC line, a second DC line and a third DC line;
a first capacitor connected between the first DC line and the second DC line;
a second capacitor connected between the second DC line and the third DC line;
a switch having a first terminal that receives an AC voltage supplied from an AC power supply, the switch being turned on when the AC power supply is sound and turned off when the AC power supply has a power failure;
an AC input filter having a first terminal connected to a second terminal of the switch;
a converter connected between a second terminal of the AC input filter and the first to third DC lines, the converter converting AC power from the AC power supply into DC power and supplying the DC power to the first to third DC lines when the AC power supply is sound;
an inverter connected between the first to third DC lines and a load, the inverter converting DC power from the first to third DC lines into AC power and supplying the AC power to the load;
a first voltage detector and a second voltage detector that detect a terminal-to-terminal voltage of the first capacitor and a terminal-to-terminal voltage of the second capacitor, respectively; and
a controller that controls the converter based on a detection value of the first voltage detector and a detection value of the second voltage detector, wherein
the AC input filter includes
a first reactor having a first terminal connected to the second terminal of the switch, and
a second reactor having a first terminal connected to the second terminal of the switch,
the converter includes
a first multi-level circuit connected between a second terminal of the first reactor and the first to third DC lines, the first multi-level circuit being configured to be able to perform conversion between an AC voltage and first to third DC voltages, and
a second multi-level circuit connected between a second terminal of the second reactor and the first to third DC lines, the second multi-level circuit being configured to be able to perform conversion between an AC voltage and the first to third DC voltages, and
the controller
calculates, based on the detection value of the first voltage detector and the detection value of the second voltage detector, a first voltage that is a sum of the terminal-to-terminal voltage of the first capacitor and the terminal-to-terminal voltage of the second capacitor, and a second voltage that is a difference between the terminal-to-terminal voltage of the first capacitor and the terminal-to-terminal voltage of the second capacitor,
controls the first multi-level circuit and the second multi-level circuit such that the first voltage is equal to a reference voltage and the second voltage is eliminated, when the AC power supply is sound, and
controls the first multi-level circuit and the second multi-level circuit such that the second voltage is eliminated, when the AC power supply has a power failure.

2. The uninterruptible power supply apparatus according to claim 1, wherein
when the AC power supply has a power failure, the controller
controls the first multi-level circuit and the second multi-level circuit such that the first capacitor is discharged and the second capacitor is charged, when the terminal-to-terminal voltage of the first capacitor is greater than the terminal-to-terminal voltage of the second capacitor, and
controls the first multi-level circuit and the second multi-level circuit such that the second capacitor is discharged and the first capacitor is charged, when the terminal-to-terminal voltage of the first capacitor is smaller than the terminal-to-terminal voltage of the second capacitor.

3. The uninterruptible power supply apparatus according to claim 2, wherein
when the AC power supply has a power failure and when the terminal-to-terminal voltage of the first capacitor is greater than the terminal-to-terminal voltage of the second capacitor, the controller is configured to alternately perform a first operation for discharging the first capacitor and a second operation for charging the second capacitor,
in the first operation, the controller controls the first multi-level circuit and the second multi-level circuit such that a current flows from a positive electrode of the first capacitor to a negative electrode of the first capacitor through the first DC line, the first multi-level circuit, the first reactor and the second reactor, the second multi-level circuit, and the second DC line,
in the second operation, the controller controls the first multi-level circuit and the second multi-level circuit such that a current flows from the second terminal of the second reactor to the second terminal of the first reactor through the second multi-level circuit, the second DC line, the second capacitor, the third DC line, and the first multi-level circuit, and
the controller stops the first operation and the second operation in response to elimination of the second voltage.

4. The uninterruptible power supply apparatus according to claim 3, wherein
the first multi-level circuit includes
a first switch connected between the first DC line and the second terminal of the first reactor,
a second switch connected between the second DC line and the second terminal of the first reactor, and
a third switch connected between the third DC line and the second terminal of the first reactor,
the second multi-level circuit includes
a fourth switch connected between the first DC line and the second terminal of the second reactor,
a fifth switch connected between the second DC line and the second terminal of the second reactor, and
a sixth switch connected between the third DC line and the second terminal of the second reactor,
in the first operation, the controller turns on the first switch and the fifth switch and turns off the second switch, the third switch, the fourth switch and the sixth switch, and
in the second operation, the controller turns on the fifth switch and turns off the first switch, the second switch, the third switch, the fourth switch and the sixth switch.

5. The uninterruptible power supply apparatus according to claim 2, wherein
when the AC power supply has a power failure and when the terminal-to-terminal voltage of the first capacitor is smaller than the terminal-to-terminal voltage of the second capacitor, the controller is configured to alternately perform a third operation for discharging the second capacitor and a fourth operation for charging the first capacitor,
in the third operation, the controller controls the first multi-level circuit and the second multi-level circuit such that a current flows from a positive electrode of the second capacitor to a negative electrode of the first capacitor through the second DC line, the second multi-level circuit, the second reactor and the first reactor, the first multi-level circuit, and the third DC line,
in the fourth operation, the controller controls the first multi-level circuit and the second multi-level circuit such that a current flows from the second terminal of the first reactor to the second terminal of the second reactor through the first multi-level circuit, the first DC line, the first capacitor, the second DC line, and the second multi-level circuit, and
the controller stops the third operation and the fourth operation in response to elimination of the second voltage.

6. The uninterruptible power supply apparatus according to claim 5, wherein
the first multi-level circuit includes
a first switch connected between the first DC line and the second terminal of the first reactor,
a second switch connected between the second DC line and the second terminal of the first reactor, and
a third switch connected between the third DC line and the second terminal of the first reactor,
the second multi-level circuit includes
a fourth switch connected between the first DC line and the second terminal of the second reactor,
a fifth switch connected between the second DC line and the second terminal of the second reactor, and
a sixth switch connected between the third DC line and the second terminal of the second reactor,
in the third operation, the controller turns on the third switch and the fifth switch and turns off the first switch, the second switch, the fourth switch and the sixth switch, and
in the fourth operation, the controller turns on the fifth switch and turns off the first switch, the second switch, the third switch, the fourth switch and the sixth switch.

7. The uninterruptible power supply apparatus according to claim 1, wherein
the AC power supply is a three-phase AC power supply,
the first reactor and the second reactor are provided to correspond to each phase of the AC power supply,
the converter includes three phase arms provided to correspond to three phases of the AC power supply, respectively, the three phase arms each including the first multi-level circuit and the second multi-level circuit, and
when the AC power supply has a power failure, the controller changes a number of phase arms to be operated depending on an absolute value of the second voltage.

8. The uninterruptible power supply apparatus according to claim 7, wherein
when the AC power supply has a power failure, the controller reduces the number of phase arms to be operated in response to a decrease in the absolute value of the second voltage.

9. The uninterruptible power supply apparatus according to claim 1, wherein
when the AC power supply is sound, the controller drives the first multi-level circuit and the second multi-level circuit in an interleaved manner.

10. The uninterruptible power supply apparatus according to claim 1, further comprising a DC voltage converter connected between a power storage device and the first to third DC lines, the DC voltage converter supplying DC power supplied from the power storage device to the first to third DC lines when the AC power supply has a power failure, wherein
when the AC power supply has a power failure, the controller controls the DC voltage converter such that the first voltage is equal to the reference voltage.

11. The uninterruptible power supply apparatus according to claim 2, wherein
the AC power supply is a three-phase AC power supply,
the first reactor and the second reactor are provided to correspond to each phase of the AC power supply,
the converter includes three phase arms provided to correspond to three phases of the AC power supply, respectively, the three phase arms each including the first multi-level circuit and the second multi-level circuit, and
when the AC power supply has a power failure, the controller changes a number of phase arms to be operated depending on an absolute value of the second voltage.

12. The uninterruptible power supply apparatus according to claim 3, wherein
the AC power supply is a three-phase AC power supply,
the first reactor and the second reactor are provided to correspond to each phase of the AC power supply,
the converter includes three phase arms provided to correspond to three phases of the AC power supply, respectively, the three phase arms each including the first multi-level circuit and the second multi-level circuit, and
when the AC power supply has a power failure, the controller changes a number of phase arms to be operated depending on an absolute value of the second voltage.

13. The uninterruptible power supply apparatus according to claim 4, wherein
the AC power supply is a three-phase AC power supply,
the first reactor and the second reactor are provided to correspond to each phase of the AC power supply,
the converter includes three phase arms provided to correspond to three phases of the AC power supply, respectively, the three phase arms each including the first multi-level circuit and the second multi-level circuit, and
when the AC power supply has a power failure, the controller changes a number of phase arms to be operated depending on an absolute value of the second voltage.

14. The uninterruptible power supply apparatus according to claim 5, wherein
the AC power supply is a three-phase AC power supply,
the first reactor and the second reactor are provided to correspond to each phase of the AC power supply,
the converter includes three phase arms provided to correspond to three phases of the AC power supply, respectively, the three phase arms each including the first multi-level circuit and the second multi-level circuit, and
when the AC power supply has a power failure, the controller changes a number of phase arms to be operated depending on an absolute value of the second voltage.

15. The uninterruptible power supply apparatus according to claim 6, wherein
the AC power supply is a three-phase AC power supply,
the first reactor and the second reactor are provided to correspond to each phase of the AC power supply,
the converter includes three phase arms provided to correspond to three phases of the AC power supply, respectively, the three phase arms each including the first multi-level circuit and the second multi-level circuit, and
when the AC power supply has a power failure, the controller changes a number of phase arms to be operated depending on an absolute value of the second voltage.

16. The uninterruptible power supply apparatus according to claim 2, wherein
when the AC power supply is sound, the controller drives the first multi-level circuit and the second multi-level circuit in an interleaved manner.

17. The uninterruptible power supply apparatus according to claim 3, wherein
when the AC power supply is sound, the controller drives the first multi-level circuit and the second multi-level circuit in an interleaved manner.

18. The uninterruptible power supply apparatus according to claim 4, wherein
when the AC power supply is sound, the controller drives the first multi-level circuit and the second multi-level circuit in an interleaved manner.

19. The uninterruptible power supply apparatus according to claim 5, wherein
when the AC power supply is sound, the controller drives the first multi-level circuit and the second multi-level circuit in an interleaved manner.

20. The uninterruptible power supply apparatus according to claim 6, wherein
when the AC power supply is sound, the controller drives the first multi-level circuit and the second multi-level circuit in an interleaved manner.
